(19) United States
(12) Patent Application Publication
(10) Pub. No.: US 2004/0068456 A1
(43) Pub. Date: Apr. 8, 2004

(54) Method of designing a personal investment portfolio of predetermined investment specifications

(76) Inventor: Semmen I. Korisch, Ekaterinburg (RU)

Correspondence Address: Paul C. Jones, SUPERTECH AMERICA, INC., Suite 200, 2221 East Street, Golden, CO, 80401, US

(21) Appl. No.: 10/265,655

(22) Filed: Oct. 7, 2002

(51) Int. Cl. G06F 17/60

(52) U.S. Cl. 705/36

(57) ABSTRACT

A method of designing an investment portfolio of stocks as a product meeting personal investment requirements of an individual investor is described. The notion of pragmatic investment (PI) is introduced and defined as the investment style based on detecting the trend of appreciation of a stock for meeting at least the requirement of a loss-free investment in the stock. The claimed method employs different criteria and ways of stock selection based on quantifying the detected trend of stock appreciation and assigning weights to the selected portfolio components in relation to their trend-related characteristics. The trend-related characteristics of a stock, herein referred to as PI-Characteristics of the stock, are defined, and the algorithms and formulas for computing these characteristics are disclosed. The PI-Characteristics are the basis of stock selection criteria. They are derived non-probabilistically from historical stock pricing data by functional transformations of the data and by removing pricing noise from the data. Examples of designing personal portfolios for bull and bear markets, as well a custom-made portfolio of limited downturns (low-noise, or “quiet” portfolio) proved effectiveness of the stock selection criteria. The notion of PI-Design is introduced and defined as a portfolio of stocks superior to any of its components and a selected market index. Computer-implementation of this invention proves practicable for accommodating the growing demand for personal investment products of strictly defined and measurable investment characteristics.

### FIELD OF THE INVENTION

The invention is in the field of designing investment portfolios of securities. More particularly, the present invention relates to designing an investment portfolio as a product meeting personal investment requirements of an individual investor.

### BACKGROUND OF THE INVENTION

After the 50-year reign of mutual funds as dominant investment vehicles for millions of individual investors, there is a growing understanding that such an investment community as a mutual fund has a deeply ingrained disadvantage for achieving different investment goals of its members.

Among most conspicuous disadvantages of a mutual fund are its size and the practical inability to properly accommodate investors of different investment terms. The attempt to reconcile the interests of short- and long-term investors results practically in that long-term investors are unwillingly becoming speculators as fund managers are forced to trade too often in attempts to not disappoint the short-term investors. The consequence of these disadvantages is that the overall results of mutual funds are rather poor or mediocre—it is widely believed that up to 80% of mutual funds underperform the stock market.

Regarding the size of a mutual fund, Peter Lynch, the famous former Fidelity Magellan Fund manager had this to say in his book, “One Up on Wall Street” (Penguin Books, 1990):

“My biggest disadvantage is size. The bigger the equity fund, the harder it gets for it to out-perform the competition. Expecting a $9-billion fund to compete successfully against an $800-million fund is the same as expecting Larry Bird to star in basketball games with a five-pound weight strapped to his waist. Big funds have the same built-in handicaps as big anything—the bigger it is, the more energy it takes to move it.”

The point is that sooner or later a successful fund becomes a victim of its own success: it is prone to deterioration of its performance after more and more people want to share this success and are pouring more and more money in the fund. That is why the era of mutual funds as the most popular institution and the investment instrument for millions of lay investors is rather over.

A reasonable answer to the question, What's next?, is in the article by Patrick McGeehan titled “Stock Baskets Aim for the Mainstream” (The New York Times, Sep. 9, 2001). It is about new investment vehicles called folios or baskets of stocks.

“Jaime Punishill, an analyst at Forrester Research in Cambridge, Mass., is convinced that stock baskets will be a staple of brokerage accounts and retirement savings plans. ‘These baskets are just a better way of putting together a portfolio of individual securities,’ he said. ‘There's no two ways about it.’”

Several inventions in the prior art aimed at providing methods for selecting stocks for a personal investment portfolio.

U.S. Pat. No. 6,317,726 to James P. O'Shaughnessy discloses a computer-implemented method of selecting corporate stocks for investment. Fifty stocks were selected from a database on the basis of certain criteria. The classical approach to valuing and selecting stocks was employed. It was an empirical search for links between return on investment in a stock and the characteristics of the balance sheet, so-called fundamentals, of the underlying company. A 43-year history of the U.S. stock market was supposed to provide long-lasting rules for selecting stocks for an investment portfolio.

However, statistical processing of the historical data was the only instrument of the research. The result are such simple statistics as the mean of the returns on a 1-year investment term and related standard deviation of the returns accompanied by an arbitrary set of 1-year investment returns computed from the lookback data. It is hardly a way for rules of stock selection in the future as in such an expanding system as a stock market these statistics may change chaotically. In fact, the so-called black-box approach to the stock market was employed. As it is known, such an approach is implicitly based on the belief that by probabilistically processing random variables at the output of a complex system and comparing it with input information is a way to discerning the inner-working of the system in a form of a non-probabilistic long-lasting relationship between system's variables. Unfortunately, that has never proved feasible or true. So, instead of the aimed answer to the question “what works on Wall Street”, there is rather an answer to the question “what worked on Wall Street” under exactly specified conditions in the past.

U.S. Pat. No. 6,415,268 to Semmen I. Korisch discloses a method of stock selection that is closest to the present invention. The method is based on detecting and quantifying the trend of appreciation of an investment in a stock in the form of a function of time of a non-probabilistic nature, called the value function of the stock. An indicator of investment value of a stock was introduced and proved effective for selecting components for a portfolio of stocks.

The inventions in the prior art disclose different methods of selecting stocks for a portfolio of stocks. However, none of them discloses a method of designing an investment portfolio of predetermined investment specifications. Notably missing are portfolios for specific investment environments of bull and bear stock markets, custom-made portfolios of limited downturns in such markets, and many other cases of accommodating personal investments.

A personal investment portfolio is defined as a product meeting personal investment requirements of an individual investor. As any other product (e.g. a personal computer) the personal portfolio has to have definite and measurable investment characteristics, in terms of an agreed standard of investment specifications.

### SUMMARY OF THE INVENTION

It is a principal object of this invention to provide a method of designing an investment portfolio of predetermined investment specifications by using different criteria and ways of selecting stocks based on recovering the trend of stock appreciation and assigning weights to the selected components in accordance with their trend-related characteristics.

It is a further object of this invention to define and develop algorithms and formulas for computing the trend-related characteristics of stocks, herein referred to as PI-Characteristics of stocks, derived non-probabilistically from historical pricing data, by functional transformations and approximations of the data, and effective as stock selection criteria for a personal investment portfolio of predetermined investment specifications.

It is still a further object of this invention to design a standard of investment specifications of a portfolio of stocks.

A computer-implemented method of designing a personal investment portfolio of predetermined investment specifications from securities participating in a capital market, herein referred to as stocks participating in a stock market, comprises the steps of:

collecting an array of pricing data of the stocks participating in the market over a period of time that is not less than a predefined lookback period;

representing the array of stock pricing data in the form of a set of functions of time, herein referred to as the pricing functions of the stocks, in the predefined lookback period of time;

computing for each member of said set of the pricing functions of the stocks the functions and PI-Characteristics of a stock derived non-probabilistically from historical stock pricing data by functional transformations and approximations of the pricing function of the stock wherein the characteristics are related to criteria of stock selection for the personal portfolio of stocks;

selecting a stock as a component of a tentative personal portfolio of stocks if the stock meets the predefined criteria related to the PI-Characteristics of the stock;

assigning weight to the selected component of the tentative portfolio of stocks in relation to the values of the PI-Characteristics of this component;

computing the pricing index of the tentative portfolio of the stocks meeting the selection criteria as a function of the weights assigned to the components of the tentative portfolio of stocks and the pricing functions of the stocks selected for the tentative portfolio of stocks;

computing on the basis of the pricing index of the tentative portfolio of the stocks the PI-Characteristics related to the requirements of the predetermined investment specifications of the personal portfolio of stocks;

repeating the steps of selecting stocks for a tentative portfolio of stocks after changing stock selection criteria if the tentative portfolio of stocks does not meet the requirements of the predetermined specifications until the number of repetitions does not exceed a predefined number of portfolio design failures, after which the market is quitted if the tentative portfolio of stock still does not meet the requirements of the predetermined specifications;

taking the tentative portfolio of stock for personal portfolio of stocks if it meets the requirements of the predetermined investment specifications of the personal portfolio of stocks;

setting up the personal portfolio of stocks based on investable funds of the owner of the personal portfolio of stocks.

### BRIEF DESCRIPTION OF THE DRAWINGS

FIG. 1 is the return functions of a stock and the function of minimum returns of the stock, in accordance with the present invention.

FIG. 2 is the value functions of stocks, the growth rate functions of the stocks and their pricing noise functions, in accordance with the present invention.

FIG. 3 is the comparison of the growth rate of stock appreciation with the growth rate of noise-free earnings (earnings trends) of the underlying company, in accordance with the present invention.

FIG. 4 is a block diagram that outlines the main steps of the present invention.

FIG. 5 is a bull-market personal portfolio of predetermined investment specifications, in accordance with the present invention.

FIG. 6 is the first stage of deterioration of a bull-market portfolio at the beginning of the market downturn, in accordance with the present invention.

FIG. 7 is the deterioration of the specifications of the bull-market portfolio in a bear market, in accordance with the present invention.

FIG. 8 is a bear-market personal portfolio of predetermined investment specifications, in accordance with the present invention.

FIG. 9 is an improvement of the bear-market portfolio by decreasing the weight of its most “noisy” component, in accordance with the present invention.

FIG. 10 is a “quiet” portfolio that meets the specification of low noise intensity, in accordance with the present invention.

FIG. 11 is a standard of investment specifications of a portfolio of stocks in the form of the portfolio of stocks containing 30 stocks of the Dow Jones Industrial Index, in accordance with the present invention.

### DETAILED DESCRIPTION OF THE INVENTION

For the purpose of detecting and quantifying (recovering) the trend of stock appreciation specific transformations and approximations of stock pricing function are required. For detecting the trend of stock appreciation, the pricing function of the stock is transformed into a function of time, herein referred to as the return function of the stock. In order to quantify the trend of appreciation of an investment in the stock, a special approximation of the pricing function of the stock is made resulting in the value function of the stock.

The return function of a stock is a function of time representing all the possible returns on investments of a given investment term over a predetermined lookback period. Building up the return function of a stock comprises the following steps:

dividing a predefined lookback period into a set of time intervals, such that each time interval is equal to the predefined lookback investment term, wherein the time intervals are separated by a predefined time-step between the beginning of a previous one and the beginning of a next one of said time intervals;

computing for each element of said set of time intervals inside the predefined lookback period a possible return on an investment lasting over the predefined lookback investment term, such as an investment is made in the beginning of an investment term and is followed by a divestment made in the end of the investment term, by comparing the ordinates of said pricing function of the stock in the end and in the beginning of the investment term, wherein the return on the investment is taken in the annualized form as an ordinate of the return function of the stock and is related to the end of the investment term.

So, the return function of a stock depends on two parameters: lookback period and lookback investment term. The first one is usually represented by two numbers—the end of the lookback period and the length of the lookback time interval, called also the lookback basis.

There is a simple formula for calculating the number of different time intervals (possible investment terms) of a given length inside a lookback period, the intervals being a month apart from each other:

S_{R}=L_{B}−T_{B}+1

where

S_{R} is the number of the investment intervals (investment terms), called also sample returns;

L_{B} is the length of a lookback period, in months;

T_{B} is the length of each investment interval, called also the lookback investment term, in months.

For each of the investment terms, the possible return on an investment made in the beginning of an investment term and divested in the end of the term, is calculated by using the following formula:

$${R}_{t} ( {L}_{B} , {T}_{B} ) = \frac{{P}_{t}}{{P}_{t - {T}_{B}}} - 1$$

(t_{b}+T_{B})=<t<=tₑ

where

Rₜ (L_{B},T_{B}) is a return on an investment of a T_{B}-month investment term ending at a time point t inside the lookback period of L_{B} months, in fractions;

P_{t-T}_{_{B}} is the stock price in the beginning of an investment term of T_{B} months;

Pₜ is the stock price in the end of an investment term of T_{B} months.

The variable t runs through all the discrete, 1-month apart, time points in the time range from t_{b}+T_{B} to tₑ inside the lookback period of L_{B} months, where t_{b} is the beginning of this lookback period, and tₑ is its end.

The set of returns, Rₜ, such as each return is considered to be an ordinate of a function of time, forms the return function of the stock, R (t, L_{B}, T_{B}):

R(t,L_{B},T_{B})=f(P(t,L_{B},),T_{B})

where

P(t) is the pricing function of a stock inside a lookback period of L_{B} months;

T_{B} is the length of the investment term;

f() is the functional transformation of the pricing function into the return function of the stock.

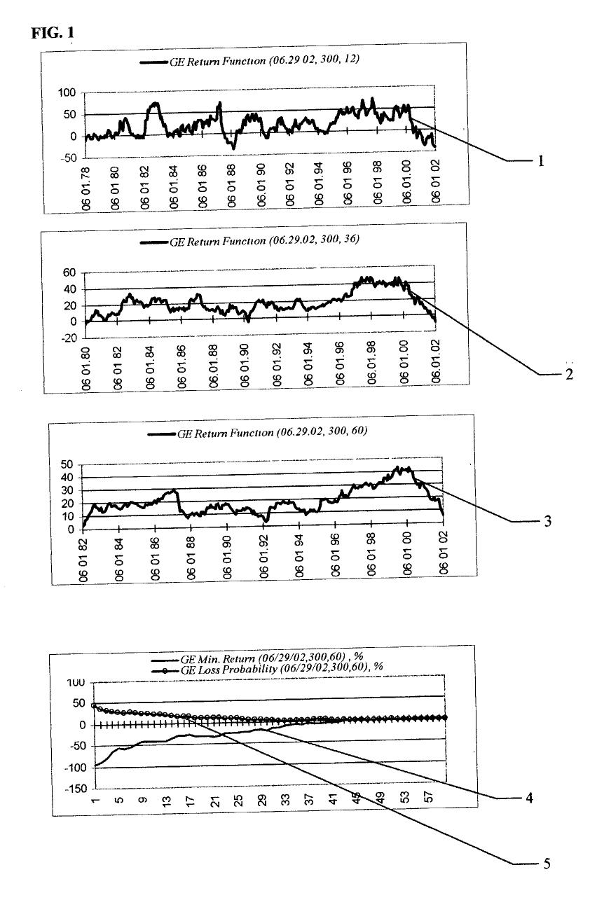

Referring now to the figures, FIG. 1 illustrates return functions of the GE stock (General Electric Corporation) over 25-year (300-month) lookback period from Jun. 30, 1977 to Jun. 30, 2002, for different lookback investment terms. The return function 1 shows all the 12-month investment results with the GE stock. It is built up on 289 ordinates (300−12+1=289) that are returns on 1-year investments in the stock; note that 21% of the 1-year investments resulted in losses of up to 41%. The return function 2 shows annualized returns on all the 265 (300−36+1=265) 3-year (36-month investments in the GE stock over the 300-month lookback period. Compared with that of 1, the return function 2 is evidently different in that much less ordinates are negative: there just 2% of 3-year investments were losses of up to 8% annualized. The return function 3 shows annualized returns on all the 241 (300−60+1=241) 5-year (60-monh) investments in the GE stock over the same lookback period. No losses had occurred on a 5-year investment.

Analyzing the return functions 1 through 3 one can conclude that a trend related to losses on investment becomes evident, that is, the longer an investment the less the probability of loss. Moreover, a quantitative threshold of a loss-free investment becomes available. In our case it is something between 3-year and 5-year investments.

The function 4 relates return on an investment to investment term. It is called the function of minimum return on investment and directly shows how the worst-case return on investment depends on investment term. There is a point on the abscissa axis where the function 4 crosses the axis; the related investment term is called the gain term of investment in a stock; in our case it is 46-month investment in the GE stock required for a loss-free investment result. Another function 5 of investment term shows how the probability of loss depends on investment term.

The above experimental data can be interpreted in a simple and consistent way: the GE stock has a trend of appreciation that compounds over time and for a sufficiently long investment term exceeds the downturns caused by the random oscillations of the stock pricing noise. So, sticking to the stock for not less than this investment term (gain term) is a way of making money in the market rather then losing them.

The foregoing allows to introduce and define the notion of pragmatic investment (PI) as the investment style based on detecting the trend of appreciation of a stock for meeting at least the requirement of a loss-free investment in the stock. The point is that the pricing noise associated with any stock is limited in scope while the compounding is an equivalent of a growing function of time until the trend of appreciation is in place. Investing in the trend of appreciation of the stock over a time required for the compounding effect to become dominant over pricing noise oscillations is what, generally, the pragmatic investment is about. The main advantage of a portfolio of stocks is that it can be less risky an investment as its noise intensity can be significantly lessened by correctly selecting portfolio components.

There are several characteristics of the return function of a stock that proved useful and helpful in guiding future investments in the stock. Such characteristics are called past-performance (or simply performance) selection characteristics of the stock, meaning a selection criteria based on these characteristics result in good components of a personal portfolio of stocks.

There is a key quantitative characteristic of a return function for detecting a trend of stock appreciation, called the focal return of the return function. It is defined as the median ordinate of the return function of the stock.

It is postulated that a stock has acquired a detectable trend of appreciation if the focal return of the return function of the stock is positive.

Return dispersion is a characteristic of the return function of the stock that characterizes the oscillations of investment returns around the focal return. It is computed by using the following formula:

$$D ( {L}_{B} , {T}_{B} ) = \frac{1 + {R}_{max} ( {L}_{B} , {T}_{B} )}{1 + {R}_{min} ( {L}_{B} , {T}_{B} )}$$

where

D(L_{B},T_{B}) is the dispersion of the returns around the focal return of the return function of L_{B} and T_{B} parameters (the predefined lookback period and the predefined lookback investment term) respectively;

Rₘₐₓ (L_{B},T_{B}); Rₘᵢₙ(L_{B},T_{B}) are maximum and minimum ordinates (returns) of the same return function, respectively, in fractions;

The most important characteristic of past performance, which is the best past-performance stock selection characteristic, is called the return reward of the stock. It is computed in accordance with the following formula:

$$RW ( {L}_{B} , {T}_{B} ) = \frac{{R}_{F} ( {L}_{B} , {T}_{B} )}{D ( {L}_{B} , {T}_{B} )}$$

where

RW(L_{B},T_{B}) is the return reward of an investment in the stock having the return function of L_{B} and T_{B} parameters (the predefined lookback period and the predefined lookback investment term) respectively;

R_{F}(L_{B},T_{B}) is the focal return of this return function;

D(L_{B},T_{B}) is the return dispersion of this return function

Last, but not least important, characteristic of investment performance of the stock is the abovementioned probability of loss on an investment of a predefined investment term. It is determined by dividing the number of the negative ordinates by all the ordinates of the return function of the stock in the predefined lookback period for the predefined lookback investment term.

The main purpose of computing a return function of a stock is to detect the trend of appreciation of the stock. Also, in many cases, past-performance stock selection criteria results in excellent personal portfolios of stocks.

For a judgment on whether the detected trend is sustainable, it has to be recovered as a function of time and its trend-related characteristics should be quantified. Relating these characteristics to stock selection criteria for a portfolio of stocks is defined as the value-based stock selection for value-based portfolio design.

The following are the basics of the value-based portfolio design. Its fundament is the following concept of the real stock value.

1. The stock market is an adaptive system that constantly factors into stock pricing data all the available information about the real value of the tock. In other words, the stock pricing data contain information about the real stock value.

2. If the trend of stock appreciation is detected (the focal return exceeds zero), the real value of the stock can be recovered (extracted), meaning directly measured or quantified, by removing the noise from the stock price.

3. The noise is the random component of the stock price that represents the ever-present uncertainty concerning the future projections on the fundamentals of the underlying company.

This concept implicitly relies on the following model of the stock market.

The stock market acts as an adaptive system containing a “transducer” that transforms its inputs, in the form of bid-ask prices, into the output of stock prices containing the information about the real stock values. Every bid or ask price may be based on some analysis involving the issuer's fundamentals, intuition or simply a guess on the investment potential of the stock, which may be more or less close to the real value of the stock. All such actions of the market participants over a sufficiently long period produce the best possible raw material for determining the real value of the stock in a form of a function of time approximating in some way the pricing function (pricing data) of the stock.

By definition, the real stock value is a slowly changing component of the stock price linked to the slowly evolving noise-free earnings (earnings trend) of the stock issuer. All other forces and causes that do not relate to those noise-free earnings result in much faster and randomly changing component of the stock price, i.e. the pricing noise of the stock. The relationship between the real stock value and the intensity of the pricing noise is different for different stocks. This relationship establishes automatically in the market over a sufficiently long period of time and does not change abruptly.

The following steps are required for recovering the real value of a stock, in the form of the value function of the stock, and the pricing noise function of the stock:

approximating the pricing function of the stock by a continuous function of time of a non-negative-derivative feature, herein referred to as a tentative value function;

computing the focal return of the tentative value function by transforming it into the return function and then determining the median ordinate of the return function;

comparing the focal return of the tentative value function with that of the pricing function;

iterating the approximation of the value function of the stock until the focal return of the return function related to the tentative value function differs from the focal return of the return function related to the pricing function of the stock by less than a small predefined limit of investment return;

computing the pricing noise function of the stock by subtracting the related ordinates of the tentative value function from the ordinates of the pricing function of the stock and dividing the differences by the related ordinates of the tentative value function of the stock;

computing the sum of the ordinates of the pricing noise function and comparing the sum with a small predefined number that should be less than one millionth, herein referred to as the limit of the error of value recovering;

adjusting the tentative value function until the error of value recovering is less than the limit of the error of value recovering by multiplying its ordinates by the factor that is equal 1 plus the average value from all the ordinates of the pricing noise function of the stock.

The value function of a stock depends on two parameters: the lookback period of recovering the value function and the lookforward investment term. Similar to the return function, the first parameter is represented by two numbers: the ending date of the lookback period and the lookback basis.

Typically, not less then a 5-year history of a stock in the market is required for a recoverable value function, if any. There are stocks in the market whose value function could not be detected whatever the price of such a stock, it has no value, just pricing noise. In the pragmatic investment, for comparing investment values of different stocks and indexes, the lookback basis is standardized as a 120-month time interval; the lookback and lookforward terms are standardized as 36-month investments.

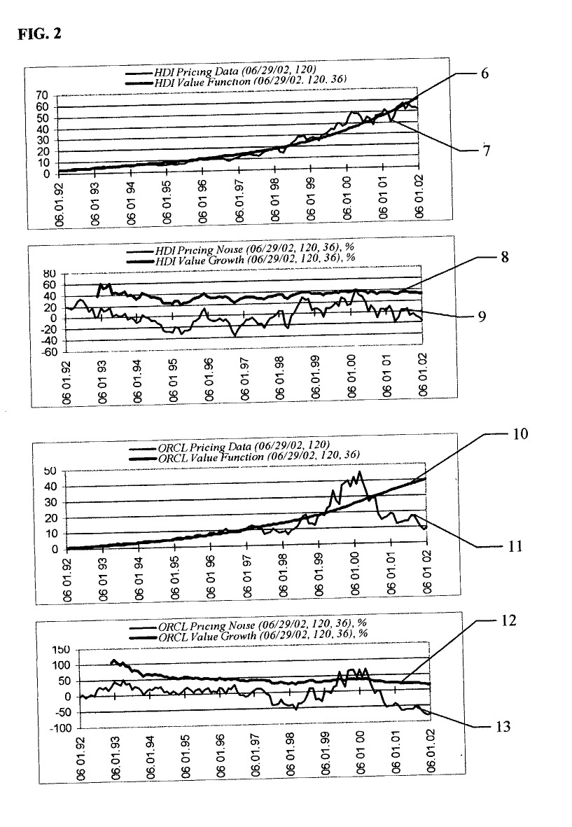

FIG. 2 exemplifies the value functions of two stocks, the HDI stock (Harley-Davidson, Inc.) and the ORCL stock (Oracle Corporation) of definitely different market attitudes to them. The value function 6 of the HDI stock is quite closely followed by the pricing functions 7 of this stock. It is more clearly visible in the graph 9 of the pricing noise function of the stock: the pricing noise is retained between the plus-minus 40% borders. The market looks quite confident about this stock—it shows not only in that the market noise associated with this stock is quite moderate; very important also that the slope of the value function, its growth rate, is a sufficiently stable function of time. Contrary to that, the value function 10 of the ORCL stock 10 followed by the pricing function 11 of this stock much less closely. Pricing noise spikes of the graph 13 are around 80%, meaning the market may overestimate the value of this stock by 80% which follows by a kind of retaliation of underestimating this stock by 80%. So, the market is more unsure about the value of the ORCL stock than about that of HDI stock. Not only the noise associated with the ORCL stock is much higher; there is a visible deterioration of the investment potential of the ORCL stock as the rate of its appreciation is declining sharply, which is clear from the graph 12. All the above-mentioned features of the stocks are evidently important and should be taken into account for portfolio design. These features are captured by quantitative characteristics of investment potential of a stock considered below.

The value function of a stock is sufficiently represented by two investment potential characteristics: the focal return of the value function and the acceleration of its growth rate.

Similar to the above-described case of determining the focal return of the pricing function of a stock via its transformation into the return function of the stock, the value function of the stock is first transformed into the return function and then the median ordinate of this return function is determined, which is taken for the focal return of the value function. Acceleration of the growth rate the value function shows how much different the growth rate of the value function in the end of a predetermined lookback period relative to the focal return of the value function, which is approximately the median growth rate of the value function:

$$A ( {t}_{e} , {L}_{B} , {T}_{F} ) = \frac{{R}_{F} ( {L}_{B} , {T}_{F} )}{{G}_{V} ( {t}_{e} , {L}_{B} , {T}_{F} )}$$

where

A(tₑ,L_{B},T_{F}) is the acceleration of the growth rate of the value function of a stock;

R_{F(L}_{B},T_{F}) is the focal return of the value function of the stock;

G_{V}(tₑ,L_{B},T_{F}) is the growth rate of the value function of the stock in the end of a lookback period;

tₑ,L_{B},T_{F} is the time points in the end of the lookback period, lookback period and lookforward investment term, respectively.

For example, referring to FIG. 2, the acceleration of the growth rate of the value function 6 of the HDI stock equals 0.95, which means that the stock excellently sustained the sharp market downturn in the last part of the exemplified lookback period. The acceleration of the growth rate of the value function 10 of the ORCL stock is 0.45; the stock lost more that half of its investment potential, which is the quantitative expression of what was described earlier as the deterioration of the investment potential of the stock.

There are two important characteristics of the pricing noise of a stock. First one is the intensity of pricing noise; second is the pricing noise divarication; they are computed in accordance with the following formulas:

$${N}_{1} ( {L}_{B} , {T}_{B} ) = \frac{1 + {N}_{P max} ( {L}_{B} , {T}_{B} )}{1 + {N}_{P min} ( {L}_{B} , {T}_{B} )}$$

N_{D}(L_{B},T_{B})=(1+N_{Pmax})×(1+|N_{Pmin}|)

where

N_{I}(L_{B},T_{B}) is the intensity of pricing noise;

N_{D}(L_{B},T_{B}) is the pricing noise divarication;

N_{Pmax}(L_{B},T_{B}) is the maximum ordinate of the pricing noise function;

N_{Pmax}(L_{B},T_{B}) is the minimum ordinate of the pricing noise function;

|N_{Pmin}| is the absolute value of the minimum ordinate of the pricing noise function;

L_{B} is the lookback period;

T_{B} is the lookback investment term.

In FIG. 2, the intensity of pricing noise 9 of the HDI stock is 2.2; divarication is 1.9. The intensity of pricing noise 13 of the ORCL stock is 8.5; divarication is 3.1. Conclusion: the ORCL stock is much riskier an investment than the HDI stock.

The following two characteristics of investment potential of a stock are called integral ones because they depend on both the investment characteristics of the value function of the stock and its pricing noise characteristics. First one is the main characteristic of investment potential of the stock; it is called the investment reward of the stock. Second one is forecast minimum return on an investment in the stock for a predefined lookforward investment term. They are computed by using the following formulas:

$$\begin{matrix}{I}_{V} ( {L}_{B} , {T}_{F} ) = \frac{{R}_{F} ( {L}_{B} , {T}_{F} )}{{N}_{1} ( {L}_{B} , {T}_{B} )} \\ {F}_{R min} ( {L}_{B} , {T}_{F} ) = {( \frac{{( {R}_{F} ( {L}_{B} , {T}_{F} ) + 1 )}^{{T}_{F}}}{{N}_{D} ( {L}_{B} , {T}_{B} )} )}^{1 / {T}_{F}} - 1\end{matrix}$$

where

I_{V}(L_{B},T_{F}) is the investment reward of the stock;

F_{Rmin}(L_{B},T_{F}) is the forecast minimum return (annualized) on an investment of a T_{F} lookforward investment term, in fractions;

R_{F}(L_{B},T_{F}) is the annualized focal return of the value function of the stock, in fractions;

N_{I}(L_{B},T_{B}) is the pricing noise intensity of the stock;

N_{D}(L_{B},T_{B}) is the pricing noise divarication of the stock.

Most of the above-considered characteristics can be used as stock selection characteristics for portfolio design. Notably outstanding for the purpose, as leading to excellent portfolios of stocks, are the following ones:

investment reward of a stock; automatic design based on a threshold of this characteristic is called value-based design;

return reward of the stock; automatic design based on a threshold of this characteristic is called performance-based design;

forecast minimum return on an investment in the stock; automatic design based on a threshold of this characteristic is called forecast-based design.

The value function of a stock may look as a formal mathematical exercise of an approximation of one function of time by another one, unless there is more reliable proof that the value function of the stock adequately represents the real value of the stock.

The following is a brief representation of such proof by the way of comparing the growth rate of the value function of a stock with the growth rate of noise-free earnings (earnings trend) of the underlying company. By the noise-free earnings is meant earning of the company in the ttm-form (trailing twelve-month earnings) whose noise was removed by exactly the same way as was the pricing noise of the stock. The comparison is conducted for the HDI stock and the ORCL stock whose value functions are shown in FIG. 2.

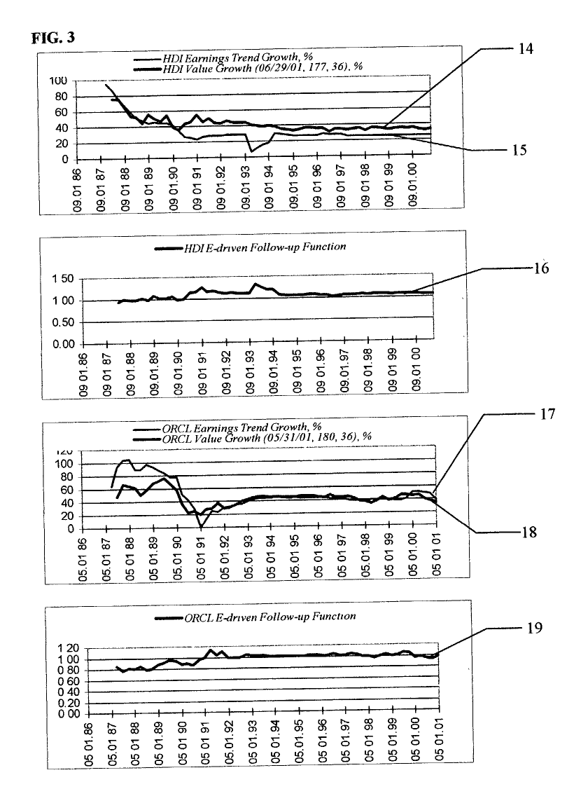

Referring to FIG. 3, curves 14 and 18 are the growth rate functions related to the value functions of the HDI stock and the ORCL stock respectively; curves 15 and 17 are the growth rates of the noise-free earnings (earnings trends) of Harley-Davidson, Inc. and Oracle Corporation, respectively. It is evident that in both cases the growth rates of the value functions are closely following the growth rates of the respective earnings trends.

The last experimental fact, which proves true for most stocks for the U.S. stock markets as well as for other markets, is generalized in the new theory of stock markets called the investment theory of stock markets, or the theory of pragmatic investment, by postulating that a stock market can be adequately modeled as a follow-up control system where the real value of a stock follows the earnings trend of the underlying company. In other words, the market is earnings-driven automatic control system that can be represented by the following basic equation:

V_{g}(t)=α_{E}(t)E_{g}(t)

where

V_{g}(t), E_{g}(t) are the growth rate functions of time of the trend of stock appreciation and the earnings trend, respectively;

α_{E}(t) is the so-called follow-up function.

Practically, the follow-up function, α_{E}(t), can be determined by dividing the ordinates of the value growth function, V_{g}(t), which is a derivative of the stock value function, by the related ordinates of the earnings growth function, E_{g}(t), which is a derivative of the earnings trend:

$${a}_{E} ( t ) = \frac{{V}_{g} ( t )}{{E}_{g} ( t )}$$

In FIG. 3, the curves 16 and 19 are the follow-up functions of the HDI stock and the ORCL stock respectively. Both are quite closely hovering arould the 1 mark, which means that error of the follow-up control is relatively low.

The follow-up error of earnings-driven system, ER_{FE}, in percent, is defined as the average of the follow-up function in a predetermined period of time minus 1 multiplied by 100:

ER_{FE}=(Avg(α_{E}(t)−1)·100

The quantitative measure of undervaluation or overvaluation of a stock (don't be confused with overpricing or underpricing of a stock) is the growth ratio:

$$G = \frac{1 + {V}_{G}}{1 + {E}_{G}}$$

where

G is the growth ratio;

V_{G} is the focal return of the value function of the stock, in fractions;

E_{G} is the focal return of the earnings trend function of the underlying corporation, in fractions.

The quantitative analysis of the relationship between the trend of appreciation of a stock and the related trend of earnings is called the earnings trend analysis. The results of the earning trend analysis for the HDI stock and the Harley-Davidson, Inc. is shown below in Table 1.

TABLE 1
Earnings Trend Analysis
PI-Report on Harley-Davidson, Inc. Earnings
Lookback Basis: Sep. 30, 1986-Jun. 30, 2001 (177 months)
Current Characteristics

| Follow-up | Earnings | Vg/Eg | E-Trend |
|---|---|---|---|
| Error | Growth | Ratio | Error |
| 12.90% | 21.61%/Yr. | 1.16 | −2.70E−16 |

What previously was qualitatively described as “close following”, now is expressed quantitatively: the follow-up error of the HDI stock is 12.9%. The growth ratio is 1.16, meaning that the HDI stock is slightly overvalued relative to the earnings trend. The E-trend error of the recovering of the earnings trend is very small, much less than a one-trillionth. This not just positively characterizes the method of arriving at the noise-free earnings, but also is due to the regularity (smoothness) of the earnings growth.

The results of the earning trend analysis for the ORCL stock and the Oracle Corporation is shown below in Table 2.

TABLE 2
Earnings Trend Analysis
PI-Report on Oracle Corporation Earnings
Lookback Basis: May 30, 1986-May 31, 2001 (180 months)
Current Characteristics

| Follow-up | Earnings | Vg/Eg | E-Trend |
|---|---|---|---|
| Error | Growth | Ratio | Error |
| −2.90% | 42.49%/Yr. | 1 | −1.30E−01 |

The follow-up error of the ORCL stock is just −2.9%. The growth ratio is 1, which means that the stock neither overvalued nor undervalued. But the E-trend error is much greater than that of the previous case, mainly, because the ups and downs of the earnings of Oracle Corporation are remarkably big and irregular. Quite likely, it is the cause of the much bigger the noise intensity of the ORCL stock compared to that of the HDI stock: it is 8.5 vs. 2.2 as it was pointed out earlier. More generally, the U.S. stock market shows all the signs of being a remarkably mature one. The proof is that for most stocks the follow-up error is relatively low, while the growth ratio is close to 1, meaning the market correctly valuates stocks, as it is meant by the investment theory of stock markets, or the theory of pragmatic investment. The conclusion is that consistently applying the theory of pragmatic investment for stock selection and portfolio design from stocks participating in the U.S. stock markets will result in excellent investment portfolios, which will be proved later.

The following Tables 3 and 4 contain all the important performance characteristics and the investment potential characteristics of the HDI stock, that is, the PI-Characteristics of the HDI stock.

TABLE 3
PI-Performance Analysis
Report on HDI (Harley-Davidson, Inc.) Returns
Lookback Basis: Jun. 30, 1992-Jun. 29, 2002 (120 mo.)
3-Year Investment Term Annualized Returns

| Current | Median | Min | Max |
|---|---|---|---|
| 23.55 | 33.08 | 14.23 | 67.14 |

Investment Risks Summary

| Return | Loss | Returns | Sample |
|---|---|---|---|
| Reward | Probability | Dispersion | Returns |
| 22.61 | 0 | 1.46 | 85 |

TABLE 4
Investment Potential Analysis
PI-Report on HDI (Harley-Davidson, Inc.)
Lookback Basis: Jun. 30, 1992-Jun. 29, 2002 (120 mo.)

| | |
|---|---|
| Investment Reward | 15.11 |

Current Investment Value Characteristics

| Price | Value | Growth | Acceleration |
|---|---|---|---|
| 51.27 | 61.07 | 31.52%/Yr. | 0.95 |

Pricing Noise and Lookforward Risks

| Current | Min/Max | Intens./Divaric. | InOut |
|---|---|---|---|
| −16.05% | −36.1%/39.9% | 2.2/1.9 | 0.71 |

Forecast on Annualized 3-Year-Term Return

| Min | Median | Max | Probability |
|---|---|---|---|
| 7% | 33% | 64% | > = 85% |

Value Error: −6.5E-15%;
Performance Error: 0.28%

PI-Characteristics of ORCL stock are shown below in Tables 5 and 6 for comparison purpose.

TABLE 5
PI-Performance Analysis
Report on ORCL (Oracle Corporation) Returns
Lookback Basis: Jun. 30, 1992-Jun. 29, 2002 (120 mo.)
3-Year Investment Term Annualized Returns

| Current | Median | Min | Max |
|---|---|---|---|
| −20.1 | 38.84 | −20.1 | 96.59 |

Investment Risks Summary

| Return | Loss | Returns | Sample |
|---|---|---|---|
| Reward | Probability | Dispersion | Returns |
| 15.78 | 8.24 | 2.46 | 85 |

TABLE 6
Investment Potential Analysis
PI-Report on ORCL (Oracle Corporation)
Lookback Basis: Jun. 30, 1992-Jun. 29, 2002 (120 mo.)

| | |
|---|---|
| Investment Reward | 4.57 |

Current Investment Value Characteristics

| Price | Value | Growth | Acceleration |
|---|---|---|---|
| 9.47 | 40.05 | 17.66%/Yr. | 0.45 |

Pricing Noise and Lookforward Risks

| Current | Min/Max | Intens./Divaric. | InOut |
|---|---|---|---|
| −76.36% | −80.0%/70.2% | 8.5/3.1 | 0.24 |

Forecast on Annualized 3-Year-Term Return

| Min | Median | Max | Probability |
|---|---|---|---|
| −5% | 38% | 101% | > = 85% |

Value Error: 1.1E-15%;
Performance Error: 0.09%

Comparing the performance of a 3-year investment of the HDI stock with that of the ORCL stock as it is represented by the return functions of these stocks in the 120-month lookback period, one can conclude that the HDI stock was a better investment. None of HDI investors incurred losses; in the worst case of a 3-year investment the return was 14% (annualized). At the same time, 8% of ORCL investors would lose up to 20% (annualized) on a 3-year investment. All the advantages of investing in HDI stock rather that in ORCL stock in the past are captured by the difference in their return rewards: it is 22.61 vs. 15.68.

The analysis of investment potential of these stock shows that the trends acquired by the stocks in the past would sustain in the future. The growth rate acceleration of the HDI stock is twice that of the ORCL stock, that is, 0.95 vs. 0.45. The worst-case forecast on a 3-year investment in the future is 7% vs. −5% annualized. All the advantages of investing in the HDI stock rather than in the ORCL stock are conspicuously represented by their respective investment rewards of 15.11 vs. 4.57.

Thousands of similar analyses followed by comparison of forecasts with actual returns prove that for middle- and long-term investments the PI-Characteristics of stocks, such as return reward, investment reward, and forecast minimum return are much more reliable stock selection criteria than the traditional P/E ratio, price/sales ratio, cashflow, market capitalization, and many-many others empirical rules of selecting stocks. It is because the PI-Characteristics of stocks are the product of conceptually novel and consistent new theory of investing in stock markets, the theory of pragmatic investment.

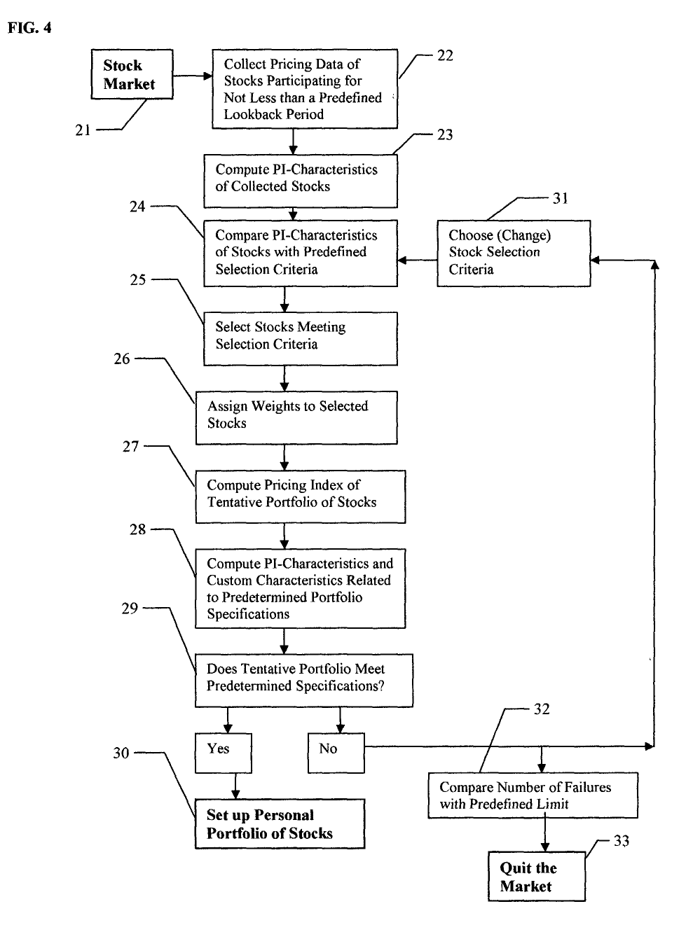

Turning now to FIG. 4, there is shown a block diagram outlining the main steps of the present invention. First step 22 involves collecting in a stock market the pricing data of stocks participating in the market for not less than a predefined lookback period required for correctly determining PI-Characteristics of the stocks. Second step 23 involves computing the PI-Characteristics of the collected stocks. Step three 24 aims at comparing PI-Characteristics of stocks with selection criteria. Step four 25 deals with selecting stocks meeting the criteria and including the stock as components of a tentative portfolio of stocks. At step five 26, weights are assigned to the selected stocks in relation to the values of their PI-Characteristics. Step six 27 involves computing the pricing index of the tentative portfolio of stocks depending on the pricing functions of the selected stock and the weights assigned to them. Step seven 28 deals with computing PI-Characteristics and custom characteristics related to the predetermined investment specifications of the personal investment portfolio. At step eight 29, the characteristics of the tentative portfolio of stocks are compared with the required characteristics meeting the predetermined portfolio specifications. If the tentative portfolio of stocks does not meet the requirements, step nine 31 involves changing stock selection criteria and repeating the steps 24 through 29. At step ten 32, the current number of the repetitions (iterations) is compared with a predefined number of allowed failures to design the predetermined portfolio. If after the predefined number of iterations the tentative portfolio of stocks still does not meet the predefined specifications, step eleven 33 to quite the market follows. If any of the iterations results in that the tentative portfolio of stocks meets the predetermined specifications, step twelve 30 deals with setting up the personal portfolio of stocks.

The step 22 of collecting pricing data of stocks involves referring to a database of stock pricing data such as provided by MSN MoneyCentral. The step 23 of defining and computing the PI-Characteristics of stocks was in detail described earlier.

The following is detailed description of the step 26, assigning the weights to selected stocks, and the step 27, computing the pricing index of a portfolio of stocks. The below example relates to the value-based portfolio design. That means that stock selection criteria is a predefined threshold of investment reward characteristic of a stock,

After selecting N stocks whose investment rewards I_{V1}, I_{V2}, . . . , I_{VN} meet the selection criteria, their weights in a portfolio should relate to the values of their investment rewards. In a simplest case, the weights are proportional to the values of the investment rewards. In more sophisticated cases, a portfolio designer or owner might want to adjust the weights by some quantitative modifiers called preferences, which are numbers between 0 and 1. So, a modified investment rewards, called the weight coefficient for the value-based design, is calculated by using the following formula:

α_{N}=p_{VN}I_{VN}

where

α_{N} is the weight coefficient for the N^{th} portfolio component;

p_{VN} is a preference for the N^{th} component;

I_{VN} is the value of the investment reward characteristic of the N^{th} component.

The sum of the weight coefficients is called normalizer, NZ:

$$NZ = {a}_{1} + {a}_{2} + … + {a}_{N} = {\sum }_{n = 1}^{n = N} {a}_{n}$$

The weight, A_{N}, of the N^{th} portfolio component, in percent, is computed by the following formula:

$${A}_{N} = \frac{{a}_{N}}{NZ} 100$$

It is easy to see that the sum of the weights equals 100%:

$$( \frac{{a}_{1}}{{a}_{1} + {a}_{2} + … + {a}_{N}} + \frac{{a}_{2}}{{a}_{1} + {a}_{2} + … + {a}_{N}} + … + \frac{{a}_{N}}{{a}_{1} + {a}_{2} + … + {a}_{N}} ) 100 = \frac{{a}_{1} + {a}_{2} + … + {a}_{N}}{{a}_{1} + {a}_{2} + … + {a}_{N}} 100 = 100$$

After the weights of the portfolio components are determined, the pricing index of the portfolio can be computed. For the matter, the pricing data of stocks are used in the so-called normalized form of data representation. What does it mean?

The common practice of splitting stocks when and how the stock issuer wants resulted in that the stock prices are inconsistent and incomparable, which makes it impossible to use them directly for portfolio design. For example, on Feb. 28, 2002, the prices of, say, the HDI stock (Harley-Davidson, Inc.) was $51.3, while that of the BRKA (Berkshire Hathaway) was $73,000. Such a confusing difference simply means that Harley-Davidson, Inc. regularly splits its stock, while Berkshire Hathaway does not, for some reasons.

As what is really important for an investor is how stock price changes over time, there is another way of representing stock prices—in the so-called normalized form. Returning to the prices of the HDI and BRKA stocks, what is important is that, say, 10 years back the HDI stock price was 14.7 times less than its current price; the BRKA stock cost 8.37 times less. So, if 10 years back both stocks cost 1 unit, currently the price of the HDI stock is 14.7 units, while the price of the BRKA stock is 8.37 units. Such pricing looks consistent and comparable for many investment-related purposes including computing the pricing index of a portfolio of stocks.

Technically, to arrive at the normalized price of a stock, its price in the beginning of a predefined lookback period is taken as a normalizer, meaning all the prices of the stock over the lookback period are divided by the normalizer. So, the normalized stock price starts from 1 in the beginning of the lookback period and in the end of the lookback period equals the number called the stock appreciation coefficient.

The above description of arriving at the normalized form of stock pricing is summed up by the following expression:

$${P}_{NZ} ( t ) = \frac{{P}_{N} ( t )}{{P}_{N} ( {t}_{b} )}$$

where

P_{NZ}(t) is the normalized pricing function of an N^{th} portfolio component;

P_{N}(t) is the in-dollar pricing function of the N^{th} component;

P_{N}(t_{b}) is the in-dollar price of the of the N^{th} portfolio component on a starting, t_{b}, date.

The pricing index of a portfolio of stocks is a function of time such as for any date the function equals the weighed sum of the normalized pricing functions of the portfolio components for the same date:

$${P}_{i} ( t ) = {A}_{1} {P}_{1 Z} ( t ) + {A}_{2} {P}_{2 Z} ( t ) + … + {A}_{N} {P}_{NZ} ( t ) = {\sum }_{n = 1}^{n = N} {A}_{n} {P}_{nZ} ( t )$$

where

Pᵢ(t) is the pricing index of the portfolio at a time point t;

Aₙ,P_{nZ}(t) is the weighed normalized price of a portfolio component at the time point t.

It is evident that at the beginning date, t_{b}, the pricing index of the portfolio equal 1, as all the normalized prices of the portfolio components are equal 1 and the sum of all the weights (when they are expressed in fractions) is also equal 1. So, the same as with any stock price in the normalized form, the portfolio pricing index starts from 1. That makes the pricing index of the portfolio consistent and comparable with the normalized pricing function of any of its components.

The formula for computing the pricing index of a portfolio of stocks can be explained as follows. Supposing that there is just a unit of currency, say, $1 to invest in a portfolio of N stocks, the part of this asset to allocate in a stock equals the weight of the stock. So, for the first stock is allocated 1*A₁=A₁ dollars; for the second one, A₂; for the N^{th} stock, A_{N}. On the beginning date, t_{b}, when the price of the first stock is P₁(t_{b}) dollars, that of the second one is P₂(t_{b}), and that of the N^{th} one is P_{N}(t_{b}), one can buy A₁/P₁(t_{b}) shares of the first stock; for the second one, A₂/P₂(t_{b}) shares; for the N^{th} one, A_{N}/P(t_{b}) shares. On any other date, t, when the price of the first stock is P₁(t), that of the second one is P₂(t); that of the N^{th} one is P_{N}(t₂), the price of the first portfolio component (the product of the component shares and its t-date price) equals P₁(t)*A₁/P₁(t_{b}); that of the second component is P₂(t)*A₂/P₂(t_{b}); that of the N^{th} one is P_{N}(t)*A_{N}/P_{N}(t_{b}). It is easy to notice that any of the last components' prices contains what is called the normalized price, that is, the t-date price divided by the normalizer, the price on the beginning date. As the portfolio price on the t-date equals the sum of the components' prices, one arrives at the above formula for computing the pricing index of the portfolio of stocks.

The pricing index of a portfolio is represented in the same normalized form as any of the portfolio components: it starts from 1 in the beginning of a lookback period and ends by the number, called portfolio appreciation coefficient, in the end of the lookback period. When the pricing index of a portfolio is computed, all the characteristics of the portfolio past performance and investment potential, the PI-Characteristics, can be determined by exactly the same way as it was shown earlier for individual stocks. That provides the possibility to compare the portfolio with its components, mutual funds or the market indexes to appraise the benefits of investing in the portfolio.

The PI-Characteristics of a portfolio proved a convenient way to express the investment specifications of the portfolio.

If the personal portfolio specifications expressed in the form of PI-Characteristics do not meet the predefined specifications there are the following options for selecting different portfolio components (the step 31, FIG. 4). First, while remaining in the same mode of design, say, the value-based design, the threshold of the investment reward of stock selection can be changed in a step-by-step manner. Second, while remaining in the same mode of design and at the same threshold, the weights of portfolio components can be changed by altering the preferences related to certain components. For example, if a tentative portfolio has noise intensity that exceeds what is required, the weights of most “noisy” components can be modified by a preference less than 1. Third, the mode of design can be changed: the performance-based design may provide a better portfolio than a value-based design. Another effective option is the forecast-based design. Forth, there is a wide range of possibilities provided by the so-called heuristic design. In this mode, the stocks are selected by one selection characteristic while the weights to the selected stocks are assigned after another one. For example, for a low-noise portfolio, the selection criteria can be a threshold of noise intensity, while the weights to the selected components are assigned in relation to their investment rewards or they are simply a consistent set of numbers indicating relative weights of the components as portfolio designer sees it.

If any of the above options has lead to a desired portfolio, step 30 (FIG. 4) follows aiming at setting up the portfolio. Setting up the personal portfolio of stocks comprises the following steps:

computing the lookback investable funds by dividing the current investable funds by the portfolio appreciation coefficient;

computing the number of shares of each stock selected for the personal portfolio of stocks by using the following formula:

$${S}_{n} = \frac{F ( {t}_{b} ) {A}_{n}}{{P}_{n} ( {t}_{b} )}$$

$$where$$

$$F ( {t}_{b} ) = \frac{F ( {t}_{e} )}{{C}_{a} ( {L}_{B} , {T}_{B} )}$$

where

Sₙ is the number of shares of an n^{th} portfolio component;

Aₙ is the weight of the n^{th} portfolio component;

F(t_{b}) is the lookback investable funds, that is, the currently available investable funds adjusted to the beginning of the lookback period;

Pₙ(t_{b}) is the price of the n^{th} portfolio component in the beginning of the lookback period;

F(tₑ) is the investable funds available at the setup moment, tₑ, that is, at the end of the lookback period;

Cₐ(L_{B},T_{B}) is the portfolio appreciation coefficient based on the portfolio pricing index for the parameters L_{B} (the lookback period) and T_{B} (the investment term);

buying the shares of selected stocks for the personal portfolio of stocks.

This ends the description of the steps of designing a personal portfolio of predetermined investment specifications.

The following are examples on personal portfolio design.

1. Bull-market Portfolio.

Requirements

A-grade portfolio: investment reward of the portfolio should be not less that 30;

PI-Design quality: the investment reward of the portfolio should be greater than that of any of its components;

Intensity of noise should be not more than 2.0.

In the bull market of late 90s, such a portfolio was possible. Just a few tries of value-based design, with different thresholds of the investment reward for selecting stocks, were sufficient to arrive at a portfolio meeting the above requirements.

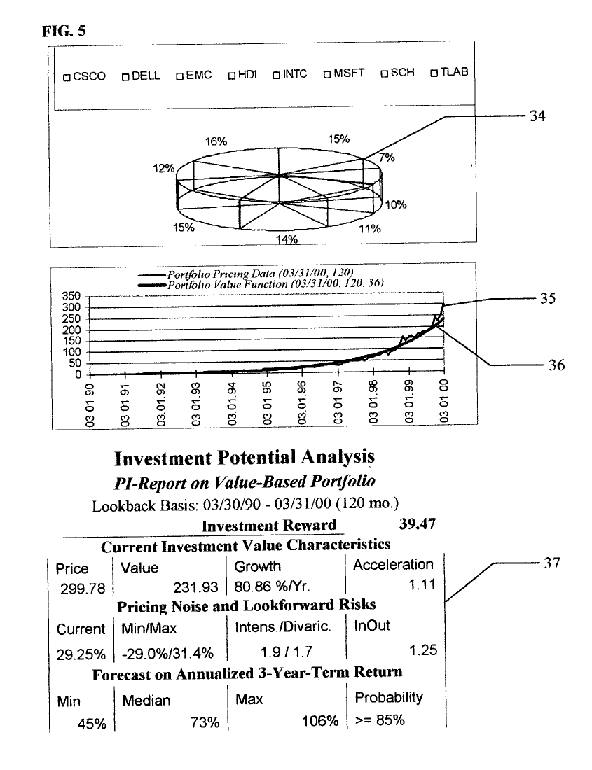

FIG. 5 displays the details of the portfolio in the end of the 120-lookback period, on Mar. 30, 2000. It is an 8-component portfolio containing the stocks of the stars of the bull market such as Cisco, Microsoft, Intel, EMC and others. Components' weights 34 (clockwise, starting from the vertical line and relating to the list of stock symbols) are proportional to the investment rewards of the components.

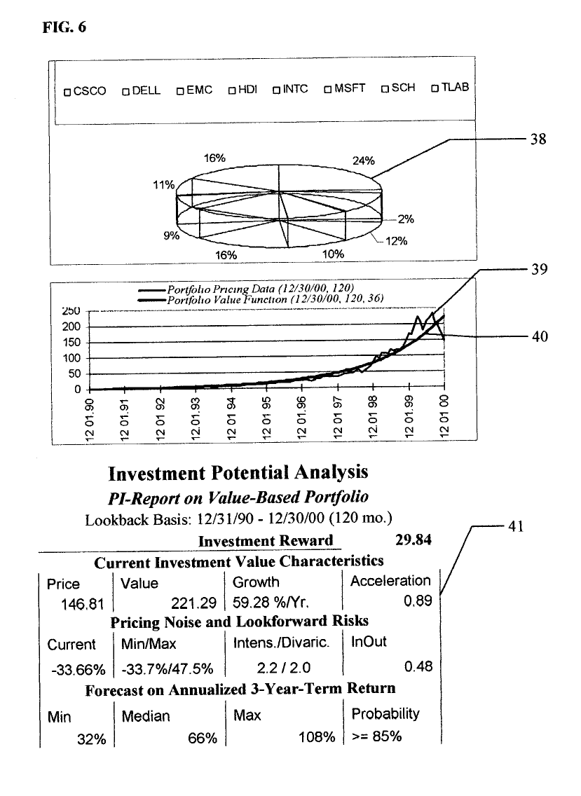

PI-Characteristics 37 of the portfolio confirms that the above requirements are met: investment reward is 39.5 vs. 30 acceptable; noise intensity is 1.9 vs. 2 acceptable. The investment reward of the components are in the range from 19.1 (MSFT) to 6.7 (DELL), which is much less than the portfolio's 39.5, so the portfolio is of the PI-Design quality; sure it is better than any of the popular market indexes Dow Jones Industrial Average, Nasdaq, or S & P 500 whose investment rewards in the end of the same lookback period were 11, 8.86, and 10.57, respectively. However, currently, that is on Mar. 31, 2000, the portfolio is not a buy, as it is significantly overpriced: the pricing index 35 of the portfolio has ran away from its value function 36 by almost 30%. For an owner of the portfolio, it is time to closely watch the portfolio status, as usually after such an overpricing a sharp downturn of portfolio price is likely to occur soon. FIG. 6 displays how the portfolio has deteriorated relatively soon, 7 months later, in the end of 120-month lookback period, on Dec. 31, 2000. The PI-Characteristics 41 do not meet more the required specifications: investment reward is below 30; noise intensity is 2.2 vs. required 2. What is more important is the speed at which the negative tendencies took place: over the short period acceleration decreased by 20%, from 1.11 to 0.89; portfolio price 39 dropped sharply below its value function 40 by 34%. Though portfolio components' weights 38 were adjusted in accordance with the changed investment rewards of the components, it is unlikely to prevent further deterioration of the portfolio.

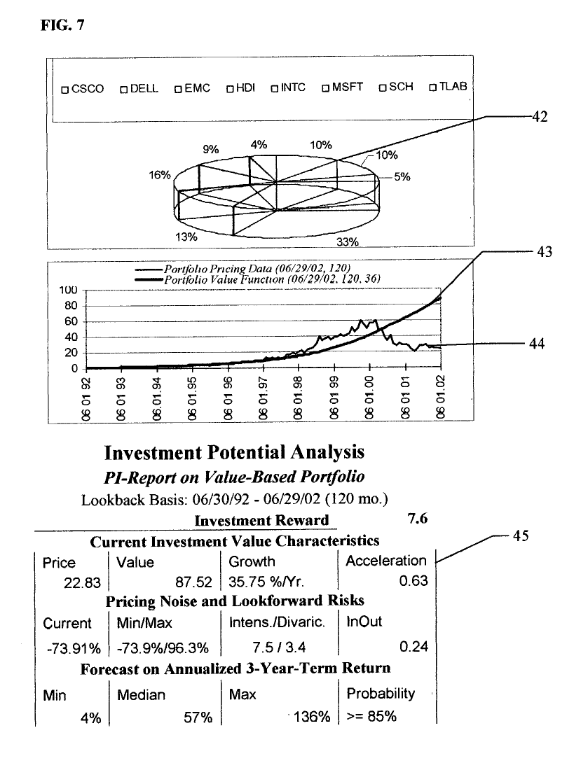

FIG. 7 displays the degree of deterioration of the bull-market portfolio in a bear market. In the end of 120-month lookback period, on Jun. 30, 2002 the PI-Characteristics 45 of the portfolio are simply terrible: investment reward is just 7.6 vs. initial 39.5 9 (8.87 and 7.87 of the Dow and S & P 500, respectively); noise intensity is 7.5 vs. initial 1.9; acceleration is 0.63 vs. initial 1.11. Portfolio price 44 dropped below its value 43 by 74%. The portfolio components' weights 42 adjusted for their changed investment rewards show the dominance of the most stable stock, the HDI, as its weight has to be 33%.

However, nothing helps the bull-market portfolio to sustain the sharp downturn to the bear market. The latter requires a different portfolio.

### 2. Bear-market Portfolio

Requirements

PI-Design quality;

Investment reward of B-grade (between 15 and 30) and not less than 2 times that of S & P 500 Index;

Noise intensity less that 2.5;

Number of components between 10 and 15

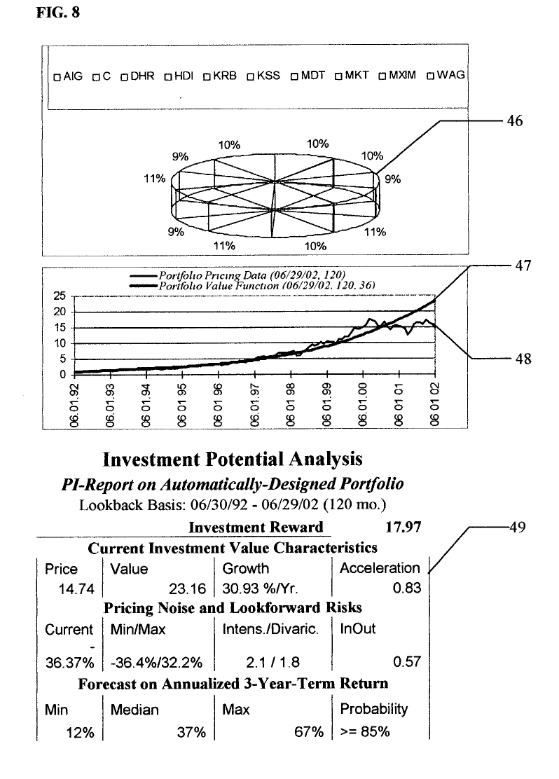

FIG. 8 shows a portfolio of stocks that meets the above requirements. It is a value-based design made by automatically selecting from the stocks listed in Appendix those whose investment rewards exceeded the threshold of 11 in the end of a 120-month lookback period on Jun. 30, 2002. PI-Characteristics 45 of the portfolio is better than the required ones: investment reward is 17.97 vs. 15 of the B-grade's low border, and it is more that two times greater than the 7.87 investment reward of S & P 500 Index; noise is 2.1 vs. acceptable 2.5. It is of PI-design quality as investment rewards of the components are in the range from 11.46 (the MXIM stock) to 15.11 (the HDI stock) vs. 17.97 of the portfolio. Of course, the portfolio was not absolutely immune to the downturn from bull to bear market—portfolio price 48 is below its value 47 by 36%. However, the portfolio showed extremely high resilience. Comparing the change of the portfolio index between a point in the last stage of the bull market, on Apr. 30, 2000, and the end of the lookback period, on Jun. 30, 2002, one can see that the portfolio price has slightly increased, from 17.45 to 17.74 (normalized), that is by 1.7%, while the S & P 500 Index dropped from 1,452 to 990, that is, by −31.8%; the Dow decreased from 10,734 to 9,243, that is, by −14%; Nasdaq decreased from 3,861 to 1,463, that is, by −62%. The point is the language of PI-Characteristics is easy to translate into the still dominant language of investment appreciation or returns on investment. Take for example the portfolio price of 14.74 at the end of the 120-month lookback period—in the normalized form that number simply means that the portfolio has appreciated by 14.74 times over 10 years. In other words, the annualized return on investment in this portfolio was 30.8%. Not bad, especially after comparing with that of the S & P 500 market: over the same period of time, the market appreciated from 408 to 990, that is, by just 2.43 times, which means 9.3% annualized. That is how the 2-times difference in their respective investment rewards translates into return on investment.

### 3. Heuristic Improvement of the Bear-market Portfolio

Considering the above portfolio as a framework of correctly selected components, there is a possibility to improve the portfolio by changing the components' weights. It is easy to notice (see Appendix) that there is a component whose noise intensity quite significantly exceeds that of all the other components: the noise intensity of the MXIM stock is 4.85 while that of others are in the range from 2.19 to 3.06. To reduce the influence of the MXIM stock on the portfolio is possible by reducing the preference assigned to this stock from 1 to, say, 0.3. That means that the weight assigned to this stock will be modified by multiplying its investment reward by 0.3 and thus decreasing its influence on the portfolio pricing index.

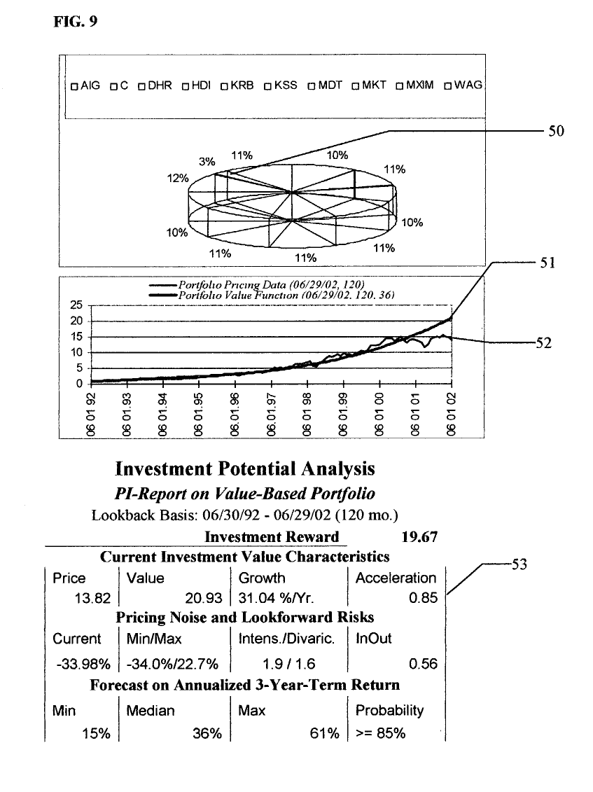

FIG. 9 shows that after the weight 50 of the MXIM component decreased from 10% to 3%, the PI-Characteristics 53 of the portfolio improved: investment reward is 19.67 vs. 17.97; noise intensity is 1.9 vs. 2.1. The portfolio meets all the above requirements but the margins between the required and the actual PI-Characteristics are better.

### 4. “Quiet” Portfolio

Requirements

Noise intensity not more than 1.5

Investment reward not less than 1.5 times that of S & P 500 Index

The portfolio is aimed at an investor who is extremely averse to the downturns of portfolio price. A tradeoff is possible between the investment reward of the portfolio and the depths of its downturns.

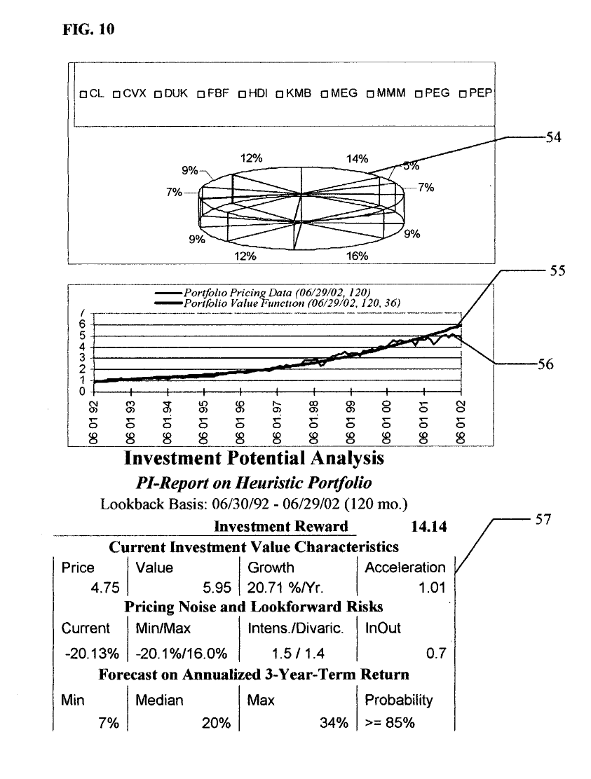

FIG. 10 shows the details of the “quiet” portfolio.

It is composed of 10 stocks under the criterion that the noise intensity of a selected component should be less than 2.2. The noise intensity of selected components is in the range from 1.52 (the CVX stock) to 2.19 (the HDI stock). The weights 54 assigned to the components are heuristic numbers reflecting designer's relative preferences to the stocks.

PI-Characteristics 57 of the portfolio show that it meets the above requirements: noise intensity is 1.5 vs. acceptable 1.5; investment reward is 14.14 vs. acceptable 11.7. Except for the HDI stock whose investment reward is 15, the investment reward of the portfolio is superior to that of other stocks—their investment rewards are in the range from 2 to 9. By the selection criterion, it is a PI-Design as the intensity of portfolio's noise of 1.5 is less than that of any component—their noise intensity is in the range from 1.52 to 2.19.

The most remarkable thing with this portfolio is that it keeps appreciating even at the market downturn: acceleration of the portfolio is slightly more that 1 while all the above exemplified portfolios have acceleration below 1. That shows in that the portfolio price 56 keeps closely following its value 55.

Again, as the normalized price of the portfolio in the end of the lookback period suggests, the “quiet” portfolio has appreciated over 10-year period by 4.75 times vs. that of S & P 500 of 2.42 times. In other words, the portfolio provided annualized return on investment of 17% vs. 9.3% of S & P 500 Index. That is how the 1.5 times difference between their investment rewards translates into return on investment.

### 5. Custom or Index Portfolio

The ever-present randomness of stock market behavior, which is taken into account in the form of the random function of time, the pricing noise function of a stock, makes it impossible formulating the target of portfolio design in pure deterministic form of optimal portfolio like “the best of the best portfolio”. More simply speaking, whatever the results of portfolio design achieved by the above-described formalized methods, there is a hope or possibility to improve the design by using some heuristic, or non-formalizable, ways of stock selection. Considering the results of, say, a value-based threshold design as a framework of a portfolio, a designer may add stocks to the portfolio or remove them simply because he or she likes or dislikes the business the underlying company is in, trusts or distrusts its management, which is impossible to quantify. When an authority recommends a list of “50 best stocks”, is there a reason to invest in the portfolio? Is it a good idea to invest in all the stocks constituting a market index? In all such cases, it is best to be consistent in assigning weights to the components in accordance with their PI-Characteristics.

For all the possible ways of selecting stocks for a portfolio of stocks, that is, by strictly formalized quantitative criteria related to PI-Characteristics of selected stocks or heuristic reasons for stock selection, this invention provides the best-known way of assessing the resulting portfolio, that is, by its PI-Characteristics.

Here comes the necessity to develop a standard of portfolio specifications in the form of PI-Characteristics of some standard portfolio. Let it be the portfolio containing stocks of some market index, say, the 30-stock portfolio of the Dow Jones Industrial Index. Unlike the Dow Jones Industrial Index itself, which is just a number representing a price of some “average” stock in the market, PI-Characteristics of the related portfolio is a kind of multidimensional representation of past performance and investment potential of the market. In such a capacity it can be referred to as Investment Dow Jones Industrial Index, or simply Investment Dow Index.

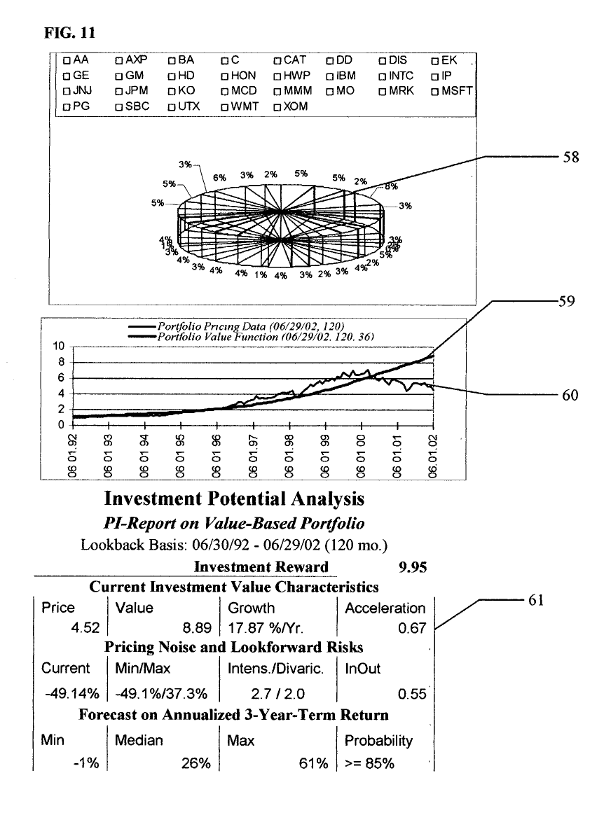

FIG. 11 illustrates a portfolio based on the 30-stock components of the Dow Index. It is a value-based design, meaning the components' weights 58 are proportional to the investment rewards of the stocks (out of 30 Dow stocks, 29 are included as the T stock (AT & T Corporation) had no detectable trend of appreciation in the chosen lookback period as its focal return was negative). The portfolio is described by its PI-Characteristics 61 that much better represent the investment potential of the market than the traditional form of the Dow Jones Industrial Index. The investment reward and the noise intensity of the Investment Dow Index of 9.95 and 2.7 respectively are the main benchmark specifications for assessing investment potential of stocks and portfolios of stocks in the given 120-month lookback period ending on Jun. 30, 2002 and for the lookforward investment term of 3 years. If predetermined specifications of a personal portfolio are expressed in the form of out-performing the Investment Dow Jones Industrial Index, or the Dow market, that would mean that at least the investment reward of the personal portfolio should be greater than the 9.95 benchmark and its noise intensity should be lower than the 2.7 benchmark. Also, the benchmark acceleration of 0.67 speaks volumes about the deterioration of the Dow market investment potential. Simply speaking, the market tells that the companies underlying the 30 Dow stocks are not ready to respond to new investment by increasing the growth rate of their earnings trends. If the acceleration characteristic of a personal portfolio is included in the list of specifications of the portfolio, out-performing the market would mean that the personal portfolio acceleration characteristic is greater than the 0.67 benchmark, which would mean that the personal portfolio contains stocks whose underlying companies are more likely to respond to investment in them by positive changes in their earnings trend.

More generally, the traditional form of the Dow Jones Industrial Index changes swiftly with the change of its components' market prices. It is fascinating to watch how one day in July, 2002 the index shoots up by 400 points producing upbeat comments of thousands of market commentators on great investment perspectives of the market; past several days, and it drops by 400 points producing a torrent of gloom forecasts on investment in the market and the economy as such. Both cases are meaningless from investment point of view. They are rather an indication of some gambling possibilities in the market, which is related to short-term characteristics of market noise and are required by gamblers and speculators of the market. Investors need different kind of information about the status of the market. And such information is contained in the Investment Dow Jones Industrial Index derived in accordance with this invention.

Similarly, other known popular indexes such as S & P 500 Index or Nasdaq Index can be converted into the form of investment indexes.

The above examples prove that the preferred embodiment of the present invention makes possible designing a personal portfolio of stocks meeting widest range of predetermined specifications (requirements) in both bull or bear markets.

This description disclosed the method of designing a personal portfolio of stocks of predetermined investment specifications by employing different criteria and ways of stock selection. The value-based portfolio design provides the possibility to meet the required specifications by changing the threshold of stock selection in the form of their investment reward characteristics. The performance-based design lets to arrive at a required portfolio by changing the level of the threshold of stock selection in the form of the return reward characteristic of a stock. The forecast-based design may result in meeting the required specifications of a portfolio by changing the threshold of stock selection based on the forecast of minimum return on an investment in the stock. Additional ways of moving a portfolio in the required direction follow from the exemplified possibility to change portfolio characteristics by the preference-modification of the weights of its components.

The present invention defined and provided algorithms and formulas for computing the trend-related characteristics, or PI-Characteristics, of a stock or a portfolio of stocks. The representation of past performance of an investment in the stock in the form of the return function of the stock provides the full set of returns on investments of a definite investment term. The most important feature of the return function is that it allows detecting a trend of appreciation, if any, of the investment in the stock: if focal return of the return function (the median ordinate of the return function) is positive the trend of appreciation is in place. The indication on how much the investors in the past benefited from this trend of appreciation is contained in the investment reward of the stock: the more the investment reward the less was the returns downturns and losses on investment. After the trend of appreciation is detected, it can be recovered in the form of the return function of the stock. The indication of how much the trend is going to be sustainable in the future provides the investment reward characteristic of the return function. It shows bow much the cumulative effect of investment appreciation is distorted by the pricing noise of the stock. In other words, how much the “noiseless” return on investment provided by this trend of appreciation would be different from actual returns in the “noisy” environment of the market. The more the investment reward of a stock the more the trend of appreciation of the stock dominates the noise associated with the stock in the market and the more the investment potential of the stock, meaning it is a more promising investment. Unlike the traditional characteristic of noise in the form of a pure probabilistic abstract such as the standard deviation, this invention defines two characteristics of the pricing noise of the stock, intensity of noise and noise divarication, as simple functions of the extremes of the noise. In such a form it is not just more understandable and intuitively perceivable, but also lets addressing what most investors are concerned with—the worst-case outcome of an investment in the stock. The formula for forecasting a minimum return on an investment of a definite lookforward investment term provides a quantitative answer to such concerns. The acceleration characteristic of the return function of a stock is an extremely important indicator of where the growth rate of the trend of appreciation is heading in comparison to the focal return of the value function.

Many of the PI-Characteristics of a stock, such as its return reward, investment reward, and forecast minimum return proved extremely useful as stock selection characteristics for a portfolio of stocks. The most important evidence of the effectiveness of using, say, a threshold of the investment reward as a criterion of stock selection lies in arriving at a portfolio called PI-Design whose PI-Characteristics are better than the ones of any of its components.

Though the language of PI-Characteristics is a quite unusual in the world of investing in stocks, there is proof that it is easy to master it quite soon. Meanwhile, as it was shown above, it is very easy to translate these characteristics into the traditional ones as the annualized return on investment, and see that the better the investment reward, the better the return on investment in the traditional form of return.

The present invention contains the method of designing a standard of investment specifications of a personal portfolio of stocks. The standard is a portfolio of stocks whose components are the stocks constituting a chosen market index, such as the Dow Jones Industrial Index, wherein the weights of the components in the portfolio are taken proportionally to the investment rewards of the stocks included in the portfolio. The pricing index of the portfolio is called the investment index of the parent market index, for example, the Investment Dow Jones Industrial Index. The current values of the PI-Characteristics of the investment index are taken as standard investment specifications of a personal portfolio of stocks.

The present invention may be utilized on a general purpose computer such as IMB-compatible PC equipped with operating system such as Microsoft Windows XP. The computer has to be linked to a network containing a database of stock pricing data (e.g. MSN MoneyCentral) by a standard modem. Productivity software such as Microsoft Office XP containing the Microsoft Excel application has to be set up on the computer. In the preferred embodiment of the present invention, the software realizing all the steps required to carry it out may be developed in the form of an add-in to the Microsoft Excel. It is preferable to use the programming language called Visual Basic for Applications (VBA) for developing the programs to carry out the steps of the present invention. The extremely powerful means contained in the Microsoft Excel Object Library and Microsoft Office Object Library in the form of virtual objects possessing dozens of useful properties and methods are the effective programming tools and environment for developing a software product required for designing a personal investment portfolio of predetermined investment specifications in accordance with the present invention.

In fact, all the described examples on portfolio design were assisted by software codes in the VBA programming language, called PI-Software, aimed at designing an excellent, PI-Design kind of, personal portfolio of stocks by an investor or an investor-service organization that is just familiar with Microsoft Excel and has mastered the basics of the pragmatic investment at the beginners level of this description.

Computer-implementation of this invention proves practicable for accommodating the growing demand for personal investment products of strictly defined and measurable investment characteristics.

While the preferred embodiment of the present invention has been described, it will be apparent to those skilled in this art that various modifications may be made in this embodiment without departing from the spirit of the present invention. Therefore, all suitable modifications and equivalents fall within the scope of the present invention that is defined in the following claims.

### Appendix

Stock Selection Database

Current on Jun. 30, 2002; Lookback Basis: 120 mo.; Lookback (Lookforward) Investment Term: 36 mo.

| | | | | | | Forecast |
|---|---|---|---|---|---|---|
| | | Focal | | | | Return |
| | | Return, | Return | Investment | Noise | Min, |
| Corporate Name | Symbol | %/Yr. | Reward | Reward | Intensity | %/Yr. |
| Alcoa Inc. | AA | 20.69 | 15.27 | 9.25 | 2.24 | −5 |
| Abbott Laboratories | ABT | 16.74 | 11.78 | 7.4 | 2.26 | −7 |
| ADVO, Inc. | AD | 8.99 | 4.99 | 1.45 | 6.19 | −32 |
| Adobe Systems Incorporated | ADBE | 15.73 | 7.92 | 3.46 | 4.55 | −23 |
| Analog Devices, Inc. | ADI | 43.11 | 20.88 | 6.08 | 7.09 | −7 |
| AES Corporation | AES | 37.14 | 11.43 | 1.91 | 19.44 | −9 |
| Wyeth | AHP | 19.38 | 13.12 | 8.1 | 2.39 | −7 |
| American International Group, Inc. | AIG | 29.42 | 20.96 | 12.78 | 2.3 | 4 |
| Applied Materials, Inc. | AMAT | 43.47 | 16.5 | 4.2 | 10.36 | −8 |
| Amgen Inc. | AMGN | 37.53 | 22.23 | 6.05 | 6.21 | −4 |
| AOL Time Warner Inc. | AOL | 105.38 | 20.14 | 2.52 | 41.85 | 7 |
| American Power Conversion | APCC | 9.08 | 4.09 | 1.29 | 7.02 | −33 |
| Corporation | | | | | | |
| Avon Products, Inc. | AVP | 15.74 | 11.17 | 6.71 | 2.35 | −10 |
| AXA | AXA | 14.06 | 4.26 | 2.69 | 5.24 | −31 |
| American Express Company | AXP | 26.92 | 17.09 | 8.97 | 3 | −3 |
| Boeing Company | BA | 9.61 | 6.26 | 3.68 | 2.61 | −16 |
| Best Buy Co., Inc. | BBY | 39.9 | 8.47 | 2.45 | 16.29 | −16 |
| Biogen, Inc. | BGEN | 29.94 | 15.45 | 6.18 | 4.84 | −13 |
| Bank of New York Company, Inc. | BK | 30.72 | 19 | 10.6 | 2.9 | 1 |
| Bristol-Myers Squibb Company | BMY | 19.57 | 9.32 | 3.88 | 5.05 | −16 |
| Citigroup Inc. | C | 34.41 | 20.71 | 13.62 | 2.53 | 6 |
| Computer Associates International, Inc. | CA | 20.16 | 7.4 | 3.39 | 5.94 | −17 |
| Caterpillar Inc. | CAT | 16.1 | 9.52 | 5.91 | 2.72 | −11 |
| Circuit City Group | CC | 11.7 | 5.61 | 1.89 | 6.19 | −28 |
| Clear Channel Communications, Inc. | CCU | 67.99 | 26.36 | 7.16 | 9.49 | 17 |
| Colgate-Palmolive Company | CL | 19.29 | 13.7 | 9.29 | 2.08 | −4 |
| CMGI, Inc. | CMGI | 83.22 | 3.14 | 0.11 | 785.82 | −22 |
| Comverse Technology, Inc. | CMVT | 49.27 | 14.27 | 1.48 | 33.24 | −10 |
| Capital One Financial Corporation | COF | 54.51 | 29.8 | 13.27 | 4.11 | 9 |
| Costco Wholesale Corporation | COST | 22.92 | 12.37 | 6.64 | 3.45 | −13 |
| Compaq Computer Corporation | CPQ | 34.55 | 11.87 | 3.04 | 11.37 | −16 |
| Compuware Corporation | CPWR | 24.46 | 5.49 | 1.86 | 13.14 | −27 |
| Cisco Systems, Inc. | CSCO | 69 | 21.44 | 4.76 | 14.5 | 8 |
| Century Tel, Inc. | CTL | 10.72 | 6.23 | 3.73 | 2.87 | −19 |
| Citrix Systems, Inc. | CTXS | 35.22 | 5.71 | 1.28 | 27.42 | −32 |
| Chevron Texaco Corporation | CVX | 10.68 | 8.1 | 7.03 | 1.52 | −3 |
| E. I. du Pont de Nemours and Company | DD | 13.42 | 8.6 | 4.41 | 3.04 | −15 |
| Dell Computer Corporation | DELL | 100.39 | 21.19 | 4.99 | 20.12 | 14 |
| Dollar General Corporation | DG | 29.46 | 16.14 | 8.07 | 3.65 | −5 |
| Danaher Corporation | DHR | 33.86 | 23.04 | 12.68 | 2.67 | 2 |
| Walt Disney Company | DIS | 13.71 | 8.89 | 4.04 | 3.39 | −16 |
| Drexler Technology Corporation | DRXR | 16.32 | 8.37 | 3.56 | 4.59 | −21 |
| Duke Energy Corporation | DUK | 7.72 | 6.5 | 4.42 | 1.75 | −10 |
| Electronic Data Systems Corporation | EDS | 8.94 | 6.06 | 3.55 | 2.52 −14 | |
| Eastman Kodak Company | EK | 2.09 | 1.13 | 0.57 | 3.68 | −25 |
| Elan Corporation, plc | ELN | 24.69 | 9.45 | 1.64 | 15.05 | −12 |
| EMC Corporation | EMC | 53.31 | 13.81 | 2.2 | 24.27 | −13 |
| Telefonaktiebolaget LM Ericsson | ERICY | 41.34 | 12.66 | 1.36 | 30.51 | −14 |
| Ford Motor Company | F | 9.1 | 5.14 | 2.71 | 3.36 | −20 |
| FleetBoston Financial Corporation | FBF | 10.56 | 6.88 | 5.13 | 2.06 | −11 |
| FedEx Corporation | FDX | 13.8 | 9.44 | 5.46 | 2.53 | −14 |
| Fiserv, Inc. | FISV | 26.25 | 18.72 | 10.86 | 2.42 | 0 |
| Fannie Mae | FNM | 17.37 | 11.71 | 7.78 | 2.23 | −6 |
| Gillette Company | G | 19.6 | 10.68 | 5.77 | 3.4 | −12 |
| Gannett Co., Inc. | GCI | 12.17 | 8.22 | 5.56 | 2.19 | −12 |
| General Dynamics Corporation | GD | 17.34 | 13.34 | 7.94 | 2.18 | −7 |
| Guidant Corporation | GDT | 49.82 | 20.86 | 9.44 | 5.28 | 6 |
| General Electric Company | GE | 30.28 | 18.8 | 8.85 | 3.42 | −1 |
| Corning Incorporated | GLW | 11.94 | 3.45 | 0.18 | 64.95 | −31 |
| General Motors Corporation | GM | 7.17 | 4.98 | 2.77 | 2.59 | −17 |
| The Gap, Inc. | GPS | 24.47 | 6.08 | 1.06 | 23.18 | −26 |
| Gateway, Inc. | GTW | 50.61 | 13.82 | 1.5 | 33.65 | −6 |
| Home Depot, Inc. | HD | 23.02 | 11.91 | 6.48 | 3.55 | −14 |
| Harley-Davidson, Inc. | HDI | 33.08 | 22.61 | 15.11 | 2.19 | 7 |
| Honeywell International Inc. | HON | 18.77 | 11.41 | 5.38 | 3.49 | −11 |
| Hershey Foods Corporation | HSY | 11.58 | 7.63 | 5.14 | 2.25 | −12 |
| Hewlett-Packard Company | HWP | 28.18 | 12.36 | 4.03 | 6.99 | −9 |
| International Business Machines | IBM | 35.38 | 16.78 | 4.57 | 7.73 | −8 |
| Corporation | | | | | | |
| Intel Corporation | INTC | 42.19 | 19.52 | 6.31 | 6.68 | −3 |
| International Paper Company | IP | 4.66 | 3.25 | 2.02 | 2.3 | −17 |
| Interpublic Group of Companies, Inc. | IPG | 19.56 | 10.55 | 4.99 | 3.92 | −15 |
| JDS Uniphase Corporation | JDSU | 108.74 | 13.7 | 0.65 | 167.81 | 16 |
| Johnson & Johnson | JNJ | 23.91 | 13.44 | 6.78 | 3.53 | −6 |
| J.P. Morgan Chase & Co. | JPM | 21.2 | 11.37 | 6.25 | 3.39 | −10 |
| Kellogg Company | K | 0.46 | 0.31 | 0.21 | 2.17 | −20 |
| KLA-Tencor Corporation | KLAC | 33.45 | 11.77 | 6.16 | 5.43 | −9 |
| Kimberly-Clark Corporation | KMB | 10.61 | 8.12 | 5.43 | 1.95 | −9 |
| Kroger Co. | KR | 28.99 | 16.29 | 8.3 | 3.49 | −5 |
| MBNA Corporation | KRB | 35.17 | 21.72 | 13.42 | 2.62 | 4 |
| Kohl's Corporation | KSS | 43.59 | 29.43 | 14.22 | 3.06 | 4 |
| Kansas City Southern | KSU | 23.14 | 6.72 | 0.88 | 26.33 | −21 |
| Lear Corporation | LEA | 2.16 | 1.1 | 0.73 | 2.96 | −24 |
| Lowe's Companies, Inc. | LOW | 27.82 | 15.93 | 6.85 | 4.06 | −9 |
| LSI Logic Corporation | LSI | 27.65 | 6.26 | 1.86 | 14.86 | −28 |
| Limited Brands, Inc. | LTD | 5.49 | 3.43 | 1.61 | 3.42 | −24 |
| Leucadia National Corporation | LUK | 3.84 | 2.68 | 1.81 | 2.12 | −17 |
| Lexmark International, Inc. | LXK | 42.85 | 18.6 | 9.2 | 4.66 | −6 |
| MBIA Inc. | MBI | 7.73 | 5.28 | 3.29 | 2.35 | −16 |
| McDonald's Corporation | MCD | 17.75 | 11.83 | 6.88 | 2.58 | −8 |
| Mercury General Corporation | MCY | 12.42 | 6.11 | 3.57 | 3.47 | −22 |
| Medtronic, Inc. | MDT | 36.16 | 23.43 | 12.42 | 2.91 | 5 |
| Media General, Inc. | MEG | 11.04 | 8.09 | 5.9 | 1.87 | −7 |
| Merrill Lynch & Co., Inc. | MER | 19.57 | 9.46 | 4.78 | 4.09 | −17 |
| Advanced Marketing Services, Inc. | MKT | 32.79 | 20.53 | 14.65 | 2.24 | 5 |
| 3M Company | MMM | 9.74 | 7.14 | 5.65 | 1.72 | −8 |
| Philip Morris Companies Inc. | MO | 7.93 | 4.37 | 2.56 | 3.09 | −19 |
| Molex Incorporated | MOLX | 14.48 | 9.39 | 5.63 | 2.57 | −14 |
| Motorola, Inc. | MOT | 6.46 | 3.27 | 1.36 | 4.75 | −31 |
| Merck & Co., Inc. | MRK | 22.58 | 13.12 | 6.85 | 3.3 | −9 |
| Microsoft Corporation | MSFT | 48.3 | 20.82 | 7.71 | 6.26 | −1 |
| Micron Technology, Inc. | MU | 35.79 | 8.13 | 2.65 | 13.5 | −25 |
| Morgan Stanley Dean Witter & Co. | MWD | 36.39 | 20.42 | 8.2 | 4.44 | −2 |
| Maxim Integrated Products, Inc. | MXIM | 55.54 | 31.22 | 11.46 | 4.85 | 10 |
| NIKE, Inc. | NKE | 11.32 | 4.69 | 2.4 | 4.72 | −25 |
| Nokia Corporation | NOK | 83.46 | 28.9 | 5.8 | 14.39 | 14 |
| National Semiconductor Corporation | NSM | 13.38 | 5.95 | 1.85 | 7.23 | −27 |
| Nortel Networks Limited | NT | 34 | 6.98 | 0.4 | 84.74 | −22 |
| Network Appliance, Inc. | NTAP | 87.92 | 24.57 | 2.08 | 42.26 | −9 |
| News Corporation Limited | NWS | 11.32 | 6.7 | 3.6 | 3.14 | −19 |
| New York Community Bancorp, Inc. | NYCB | 35.52 | 20.6 | 11.33 | 3.14 | 3 |
| Omnicom Group Inc. | OMC | 31.26 | 15.87 | 7.01 | 4.46 | −6 |
| Oracle Corporation | ORCL | 38.84 | 15.78 | 4.57 | 8.49 | −5 |
| Pitney Bowes Inc. | PBI | 9.79 | 5.6 | 3.14 | 3.12 | −20 |
| PACCAR Inc | PCAR | 9.23 | 5.66 | 3.54 | 2.61 | −18 |
| Public Service Enterprise Group | PEG | 4.11 | 3.1 | 2.35 | 1.75 | −12 |
| Incorporated | | | | | | |
| PepsiCo, Inc. | PEP | 10.37 | 7.56 | 5.18 | 2 | −9 |
| Pfizer Inc | PFE | 33.99 | 18.59 | 8.51 | 3.99 | −8 |
| Procter & Gamble Company | PG | 21.39 | 13.6 | 7.82 | 2.74 | −6 |
| Progressive Corporation | PGR | 15.17 | 7.24 | 3.59 | 4.22 | −20 |
| PerkinElmer, Inc. | PKI | 9.99 | 3.77 | 0.22 | 44.68 | −29 |
| QUALCOMM Incorporated | QCOM | 44.76 | 12.48 | 2.32 | 19.27 | −33 |
| QLogic Corporation | QLGC | 116.66 | 30.98 | 3.12 | 37.41 | 3 |
| QLT Inc. | OLTI | 37.97 | 14.55 | 2.9 | 13.09 | −20 |
| Reliant Energy, Incorporated | REI | 5.55 | 2.61 | 0.55 | 10.14 | −43 |
| Reuters Group PLC | RTRSY | 12.21 | 6.8 | 2.41 | 5.07 | −20 |
| SBC Communications Inc. | SBC | 13.79 | 8.36 | 5.25 | 2.63 | −11 |
| Starbucks Corporation | SBUX | 31.43 | 16.73 | 7.28 | 4.32 | −3 |
| Charles Schwab Corporation | SCH | 54.68 | 17.05 | 4.46 | 12.26 | −8 |
| Sealed Air Corporation | SEE | 19.79 | 10.38 | 5.67 | 3.49 | −14 |
| Safeguard Scientifics, Inc. | SFE | 48.64 | 8.59 | 0.87 | 56.02 | −17 |
| Schering-Plough Corporation | SGP | 25.34 | 12.02 | 5.21 | 4.87 | −14 |
| Smith International, Inc. | SII | 23.05 | 12.94 | 4.21 | 5.47 | −20 |
| Schlumberger Limited | SLB | 8.51 | 5.2 | 2.95 | 2.89 | −21 |
| Solectron Corporation | SLR | 39.16 | 10.98 | 2.54 | 15.44 | −13 |
| Staples, Inc. | SPLS | 35.32 | 18.79 | 7.32 | 4.82 | −7 |
| Sun Microsystems, Inc. | SUNW | 60.6 | 17.09 | 1.97 | 30.73 | −7 |
| Safeway Inc. | SWY | 53.09 | 25.8 | 7.32 | 7.26 | 9 |
| Teradyne, Inc. | TER | 32.04 | 12.94 | 3.99 | 8.03 | −21 |
| Tellabs, Inc. | TLAB | 54.75 | 9.7 | 2.05 | 26.73 | 2 |
| Toyota Motor Corporation | TM | 9.89 | 7.3 | 4.07 | 2.43 | −15 |
| Texas Instruments Incorporated | TXN | 34.25 | 14.54 | 5.16 | 6.64 | −19 |
| Tyco International Ltd. | TYC | 37.07 | 14.47 | 4.04 | 9.19 | −4 |
| Unilever N.V. | UN | 9.94 | 6.49 | 4.23 | 2.35 | −15 |
| United Technologies Corporation | UTX | 27.42 | 19.06 | 9.81 | 2.8 | −2 |
| Viacom Inc. | VIA | 7.95 | 3.72 | 2 | 3.97 | −24 |
| Vitesse Semiconductor Corporation | VTSS | 90.02 | 16.53 | 0.65 | 137.85 | 7 |
| Walgreen Co. | WAG | 34.18 | 22.71 | 13.51 | 2.53 | 3 |
| WorldCom Group | WCOM | 35.98 | 5.37 | 0.26 | 135.89 | −12 |
| Wells Fargo & Company | WFC | 18.56 | 12.54 | 8.16 | 2.28 | −7 |
| Wind River Systems, Inc. | WIND | 30.52 | 8.22 | 1.72 | 17.75 | −18 |
| Williams Companies, Inc. | WMB | 27.81 | 9.6 | 1.83 | 15.23 | −12 |
| Wal-Mart Stores, Inc. | WMT | 20.99 | 9.84 | 5.16 | 4.06 | −15 |
| Xilinx, Inc. | XLNX | 44.82 | 19.61 | 5.6 | 8 | −8 |
| Exxon Mobil Corporation | XOM | 12.99 | 7.81 | 4.11 | 3.16 | −13 |
| Yahoo! Inc. | YHOO | 150.84 | 6.68 | 1.29 | 116.74 | −10 |

What is claimed is:

1. A computer-implemented method of designing a personal investment portfolio of predetermined investment specifications from securities participating in a capital market, herein referred to as stocks participating in a stock market, comprising the steps of:
collecting an array of pricing data of the stocks participating in the market over a period of time that is not less than a predefined lookback period;
representing the array of stock pricing data in the form of a set of functions of time, herein referred to as the pricing functions of the stocks, in the predefined lookback period of time;
computing for each member of said set of the pricing functions of the stocks the following functions and characteristics of a stock, herein referred to as PI-Characteristics of the stock, derived non-probabilistically from historical stock pricing data by functional transformations and approximations of the pricing function of the stock, wherein the characteristics are related to criteria of stock selection for the personal portfolio of stocks:
past performance representation of the stock in the form of a function of time, herein referred to as the return function of the stock, in the predefined lookback period for a predefined lookback investment term;
past performance characteristics of the stock as functions of the ordinates of the return function of the stock;
a trend of appreciation of an investment in the stock in the form of a function of time of a non-probabilistic nature, herein referred to as the value function of the stock, by removing pricing noise from the pricing function of the stock, for a predefined lookforward investment term;
a random function of time, herein referred to as the pricing noise function of the stock, wherein the ordinates of the pricing noise function of the stock depend on the related ordinates of the value function of the stock and the pricing function of the stock;
investment potential characteristics of the stock based on the growth rate of the value function of the stock;
pricing noise characteristics of the stock related to the oscillation of future returns around the returns suggested by the trend of appreciation of the stock, as functions of the ordinates of the pricing noise function of the stock;
integral investment potential characteristic of the stock as functions of both the investment potential characteristics of the stock and the pricing noise characteristic of the stock;
custom-defined selection characteristics of the stock based on personal preferences of an individual investor;
selecting a stock as a component of a tentative personal portfolio of stocks if the stock meets the predefined criteria related to the PI-Characteristics of the stock;
assigning weight to the selected component of the tentative portfolio of stocks in relation to the values of the PI-Characteristics of this component;
computing the pricing index of the tentative portfolio of stocks as a function of the weights assigned to the components of the tentative portfolio of stocks and the pricing functions of the stocks selected for the tentative portfolio of stocks;
computing on the basis of the pricing index of the tentative portfolio of stocks the following PI-Characteristics related to the predetermined investment specifications of the personal portfolio of stocks:
representation of past performance of the tentative portfolio of stocks in the form of the return function of the tentative portfolio of stocks in the predefined lookback period for the predefined lookback investment term;
past performance characteristics of the tentative portfolio of stocks as functions of the ordinates of the return function of the tentative portfolio of stocks;
a trend of appreciation of an investment in the tentative portfolio of stocks in the form of the value function of the tentative portfolio of stocks, by removing pricing noise from the pricing index of the tentative portfolio of stocks;
a random function of time, in the form of the pricing noise function of the tentative portfolio of stocks, wherein the ordinates of the pricing noise function of the tentative portfolio of stocks are functions of related ordinates of the value function of the tentative portfolio of stocks and the pricing index of the tentative portfolio of stocks;
investment potential characteristics of the tentative portfolio of stocks based on the growth rate of the value function of the tentative portfolio of stocks;
pricing noise characteristics of the tentative portfolio of stocks as functions of the ordinates of the pricing noise function of the tentative portfolio of stocks;
integral investment potential characteristics of the tentative portfolio of stocks as functions of both the investment potential characteristics of the tentative portfolio of stocks and the pricing noise characteristic of the tentative portfolio of stock;
custom-defined investment characteristics of the tentative portfolio of stocks;
repeating the steps of selecting stocks for a tentative portfolio of stocks after changing stock selection criteria if the tentative portfolio of stocks does not meet the requirements of the predetermined specifications until the number of repetitions does not exceed a predefined number of portfolio design failures, after which the market is quitted if the tentative portfolio of stock still does not meet the requirements of the predetermined specifications;
taking the tentative portfolio of stock for the personal portfolio of stocks if it meets the requirements of the predetermined investment specifications of the personal portfolio of stocks;
setting up the personal portfolio of stocks based on investable funds of the owner of the personal portfolio of stocks.

2. The method of claim 1 wherein the step of computing the representation of past performance of a stock or a portfolio of stocks in the form of the return function of the stock or the portfolio of stocks in the predefined lookback period for the predefined lookback investment term, comprises the following steps:
dividing the preset lookback period into a set of time intervals, such that each time interval is equal to the predefined lookback investment term, wherein the time intervals are separated by a predefined time-step between the beginning of a previous one and the beginning of a next one of said time intervals;
computing for each element of said set of time intervals inside the predefined lookback period a possible return on an investment lasting over the predefined lookback investment term, such as an investment is made in the beginning of an investment term and is followed by a divestment made in the end of the investment term, by comparing the ordinates of said pricing function of the stock or said pricing index of the portfolio of stocks in the end and in the beginning of the investment term, wherein the return on the investment is taken in the annualized form as an ordinate of the return function of the stock or the portfolio of stocks and is related to the end of the investment term;
referring the pricing function of the stock or the pricing index of the portfolio of stocks related to their respective return functions as respective parents of the return functions.

3. The method of claim 1 wherein the step of computing past performance characteristics of a stock or a portfolio of stocks in the predefined lookback period for the predefined lookback investment term comprises the following steps:
defining the focal return of a return function as the median ordinate of the return function of the stock or the portfolio of stocks, herein also referred to as the focal return of the pricing function, or the focal return of the pricing index, or the focal return of the value function of the stock or the portfolio of stocks depending on the parent of the return function;
computing the dispersion of returns on an investment of the predefined lookback investment term in the predefined lookback period by using the following formula:
$$D ( {L}_{B} , {T}_{B} ) = \frac{1 + {R}_{max} ( {L}_{B} , {T}_{B} )}{1 + {R}_{min} ( {L}_{B} , {T}_{B} )}$$
where
D(L_{B},T_{B}) is the dispersion of the returns around the focal return of the return function of L_{B} and T_{B} parameters (the predefined lookback period and the predefined lookback investment term) respectively;
Rₘₐₓ(L_{B},T_{B}); Rₘᵢₙ(L_{B},T_{B}) are maximum and minimum ordinates (returns) of the same return function, respectively, in fractions;
computing the return reward characteristic of the stock or the portfolio of stocks by using the following formula:
$$RW ( {L}_{B} , {T}_{B} ) = \frac{{R}_{F} ( {L}_{B} , {T}_{B} )}{D ( {L}_{B} , {T}_{B} )}$$
where
RW(L_{B},T_{B}) is the return reward of an investment in the stock or the portfolio of stocks having the return functions of L_{B} and T_{B} parameters (the predefined lookback period and the predefined lookback investment term) respectively;
R_{F}(L_{B},T_{B}) is the focal return of this return function;
D(L_{B},T_{B}) is the return dispersion of this return function
computing the loss probability of an investment in a stock or a portfolio of stocks by dividing the number of the negative ordinates by all the ordinates of the return function of the stock or the portfolio of stocks in the predefined lookback period for the predefined lookback investment term.

4. The method of claim 1 wherein the step of computing the trend of appreciation of an investment in a stock or a portfolio of stocks in the form of the value function of the stock or the portfolio of stocks by removing noise from the pricing function of the stock or the pricing index of the portfolio of stocks comprises the following steps:
approximating said pricing function of the stock or the pricing index of the portfolio of stocks by a continuous function of time of a non-negative-derivative feature, herein referred to as a tentative value function;
computing the focal return of the tentative value function by using the steps of claim 3;
comparing the focal return of the tentative value function with that of the pricing function or the pricing index;
iterating the approximation of the value function of the stock or the portfolio of stocks until the focal return of the return function related to the tentative value function differs from the focal return of the return function related to the pricing function of the stock or the pricing index of the portfolio of stocks by less than a small predefined limit of investment return;
computing the pricing noise function of the stock or the portfolio of stocks by subtracting the related ordinates of the tentative value function from the ordinates of the pricing function of the stock or the pricing index of the portfolio of stocks and dividing the differences by the related ordinates of the tentative value function of the stock or the portfolio of stocks;
computing the sum of the ordinates of the pricing noise function and comparing the sum with a small predefined number that should be less than one-millionth, herein referred to as the limit of the error of value recovering;
adjusting the tentative value function until the error of value recovering is less than the limit of the error of value recovering by multiplying the ordinates of the tentative value function by the factor that is equal 1 plus the average value from all the ordinates of the pricing noise function of the stock or the portfolio of stocks;

5. The method of claim 1 wherein the step of computing the investment potential characteristics of a stock or a portfolio of stocks comprises the following steps:
computing the focal return of the value function of the stock or the portfolio of stocks by using the steps of claim 3 and interpreting it as the median rate of appreciation of an investment in the stock or the portfolio of stocks;
computing the derivative of the value function of the stock or the portfolio of stocks in the end of the predefined lookback period, the derivative herein referred to as the current appreciation of an investment in the stock or the portfolio of stocks;
computing the acceleration characteristic of the value function of the stock or the portfolio of stocks by dividing said current appreciation by the focal return of the value function of the stock or the portfolio of stocks;

6. The method of claim 1 wherein the step of computing the pricing noise characteristics of a stock or a portfolio of stocks comprises the following steps:
computing the characteristic of intensity of pricing noise by using the following formula:
$${N}_{1} ( {L}_{B} , {T}_{B} ) = \frac{1 + {N}_{{P}_{max}} ( {L}_{B} , {T}_{B} )}{1 + {N}_{{P}_{min}} ( {L}_{B} , {T}_{B} )}$$
where
N_{I}(L_{B},T_{B}) is the intensity of pricing noise;
N_{Pmax}(L_{B},T_{B}) is the maximum ordinate of the pricing noise function;
N_{Pmax}(L_{B},T_{B}) is the minimum ordinate of the pricing noise function;
L_{B} is the lookback period;
T_{B} is the lookback investment term
computing the characteristic of forecast-return range, herein referred to as the pricing noise divarication:
N_{D}(L_{B},T_{B})=(1+N_{Pmax})×(1+|N_{Pmin}|)
where
N_{D}(L_{B},T_{B}) is the pricing noise divarication;
N_{Pmax} is the maximum ordinate of the pricing noise function;

|N_{Pmin}| is the absolute value of the minimum ordinate of the pricing noise function;

7. The method of claim 1 wherein the step of computing the integral investment potential characteristic of a stock or a portfolio of stocks comprises the following steps:
computing the main characteristic of the investment potential of the stock or the portfolio of stock, herein referred to as the investment reward of the stock or the portfolio of stocks, by using the following formula:
$${I}_{V} ( {L}_{B} , {T}_{F} ) = \frac{{R}_{F} ( {L}_{B} , {T}_{F} )}{{N}_{I} ( {L}_{B} , {T}_{B} )}$$
where
I_{V}(L_{B},T_{F}) is the investment reward of the stock or the portfolio of stocks;
R_{F}(L_{B},T_{F}) is the focal return of the value function of the stock or the portfolio of stocks;
N_{I}(L_{B},T_{B}) is the intensity of the pricing noise of the stock or the portfolio of stocks;
computing the forecast of the minimum annualized return on an investment in the stock or the portfolio of stocks by using the following formula:
$${F}_{Rmin} ( {L}_{B} , {T}_{F} ) = {( \frac{{( {R}_{F} ( {L}_{B} , {T}_{F} ) + 1 )}^{{T}_{F}}}{{N}_{D} ( {L}_{B} , {T}_{B} )} )}^{\frac{1}{{T}_{F}}} - 1$$
where
F_{Rmin}(L_{B},T_{F}) is the forecast minimum return on an investment of T_{F} lookforward investment term;
N_{D}(L_{B},T_{B}) is the pricing noise divarication characteristic of the stock or the portfolio of stocks.

8. The method of claim 1 wherein stock selection criterion is a threshold of one of the following selection characteristics, such as the level of the threshold is changed iteratively in a step-by-step manner if a tentative portfolio of selected stocks related to a certain level of the threshold of stock selection does not meet the predetermined specifications of the personal portfolio of stocks:
return reward of the stock; the portfolio design based on this criterion herein referred to as the performance-based threshold design;
investment reward of the stock; the portfolio design based on this criterion herein referred to as the value-based threshold design;
forecast minimum return on investment in the stock for the predefined lookforward investment term; the portfolio design based on this criterion herein referred to as the forecast-based threshold design.

9. The method of claims 1 wherein the weight assigned to a component of the tentative portfolio of stocks is proportional to the value of the selection characteristic related to the performance-based design, value-based design, and forecast-based design respectively;

10. The method of claims 1 wherein the weight assigned to a component of the tentative portfolio of stocks is proportional to the value of the selection characteristics related to the performance-based design, value-based design or forecast-based design respectively modified by one of the following ways:
multiplying the value of the characteristic by a number in the range from 0 to 1 depending on the personal preferences of an individual investor for the stock or its issuer;
multiplying the value of the characteristic by a number that is equal 1 minus the probability (in fractions) of the loss on an investment in the stock for the predefined lookback investment term;

11. The method of claim 1 wherein the weights assigned to the components of the tentative portfolio of stocks are of heuristic nature and are proportional to some consistent set of numbers indicating the relative preferences of an individual investor for the selected stocks or their issuers.

12. The method of claim 1 wherein the step of computing the pricing index of the tentative portfolio of stocks comprises the following steps:
representing each pricing function of the stocks selected for the tentative portfolio of stocks in the normalized form by dividing the ordinates of the pricing function of a stock by the ordinate of the pricing function of the stock in the beginning of the lookback period, such as all the normalized pricing functions become consistent in that they start from 1 and end by a number indicating the growth of the stock price over the predefined lookback period, the number herein referred to as the stock appreciation coefficient;
computing an ordinate of the pricing index related to a time-point t inside the predefined lookback period as a sum of the ordinates of the normalized pricing functions of the selected components related to the same time-point t, wherein each ordinate is modified by the weight of the respective component of the tentative portfolio of stocks, in accordance with the following formula:
$${P}_{i} ( t ) = {A}_{1} {P}_{1 Z} ( t ) + {A}_{2} {P}_{2 Z} ( t ) + … + {A}_{N} {P}_{NZ} ( t ) = {\sum }_{n = 1}^{n = N} {A}_{n} {P}_{nZ} ( t )$$
where
$${\sum }_{n = 1}^{n = N} {A}_{n} = 1$$
where
Pᵢ(t) is an ordinate of the pricing index of the tentative portfolio at a time point t;
P_{nZ}(t) is the normalized price of an n^{th} tentative portfolio component at the time-point t;
Aₙ is the weight of the n^{th} tentative portfolio component;
N is the number of selected components.
representing the pricing index of the tentative portfolio of stocks as a function of time whose ordinates are computed in accordance with the above formula for all the time-points inside the predefined lookback period, wherein the pricing index is represented in the normalized form starting from 1 and ending by a number indicating the growth of the pricing index over the predefined lookback period, the number herein referred to as the portfolio appreciation coefficient.

13. The method of claim 1 wherein the step of setting up the personal portfolio of stocks comprises the following steps:
computing the lookback investable funds by dividing the current investable finds by the portfolio appreciation coefficient;
computing the number of shares of each stock selected for the personal portfolio of stocks by using the following formula:
$$\begin{matrix}{S}_{n} = \frac{F ( {t}_{b} ) {A}_{n}}{{P}_{n} ( {t}_{b} )} \\ where \\ F ( {t}_{b} ) = \frac{F ( {t}_{e} )}{{C}_{a} ( {L}_{B} , {T}_{B} )}\end{matrix}$$
where
Sₙ is the number of shares of the n^{th} portfolio component;
Aₙ is the weight of the n^{th} portfolio component;
F(t_{b}) is the lookback investable funds, that is, the currently available investable funds adjusted to the beginning of the lookback period;
Pₙ(t_{b}) is the price of the n^{th} portfolio component in the beginning of the lookback period;
F(tₑ) is the investable funds available at the setup moment, tₑ, that is, at the end of the lookback period;
Cₐ(L_{B},T_{B}) is the portfolio appreciation coefficient based on the portfolio pricing index for the parameters L_{B} (the lookback period) and T_{B} (the investment term);
buying the shares for the personal portfolio of stocks.

14. A method of designing a standard of investment specifications of a portfolio of stocks in the form of a portfolio containing all the stocks constituting a predetermined market index, herein referred to as the standard portfolio, comprising the steps of:
computing the investment reward characteristics of the components of the standard portfolio in the predefined lookback period for a predefined lookforward investment term by using the steps of claim 7;
assigning to each component of the standard portfolio the weight that is proportional to the value of the investment reward characteristic of the component;
computing the pricing index of the standard portfolio of stocks by using the steps of claim 12, wherein the pricing index of the standard portfolio of stocks is referred to as the investment index of said market index;
computing the PI-Characteristics of said investment index in the predefined lookback period for the predefined lookback and lookforward investment terms by using the steps of claims 2 through 7;
taking the values of the PI-Characteristics of the investment index as the multidimensional standard of investment specifications of a portfolio of stocks in the predefined lookback period for the predefined lookback and lookforward investment terms.
